(19) United States
(12) Patent Application Publication
(10) Pub. No.: US 2012/0065910 A1
(43) Pub. Date: Mar. 15, 2012

(54) RESISTANCE VALUE CALCULATING METHOD AND RESISTANCE VALUE CALCULATING DEVICE

(75) Inventor: Hironobu YOSHINO, Kawasaki (JP)

(73) Assignee: FUJITSU LIMITED, Kawasaki (JP)

(21) Appl. No.: 13/224,591

(22) Filed: Sep. 2, 2011

(30) Foreign Application Priority Data
Sep. 9, 2010 (JP) 2010-202193

(51) Int. Cl. G06F 19/00

(52) U.S. Cl. 702/65

(57) ABSTRACT

A resistance value calculating method of a computer calculating a resistance value of a wiring of a semiconductor circuit device, the method includes dividing the wiring into rectangular regions where each of the regions has an orthogonal coordinate system and are mutually not contained, drawing a first line segment up to a front of an edge portion of an overlapped region in which a first divided region and a second divided region overlap in a longitudinal direction of a center portion of the first region, drawing a second line segment in a longitudinal direction of a center portion of the second region after the first line segment is drawn, and calculating a resistance value of the first region and the second region in accordance with a length of each line segment and a width of each region.

### CROSS-REFERENCE TO RELATED APPLICATION

This application is based upon and claims the benefit of priority of the prior Japanese Patent Application No. 2010-202193, filed on Sep. 9, 2010, the entire contents of which are incorporated herein by reference.

### FIELD

Embodiments of the present invention relate to a resistance value calculating method and a resistance value calculating device.

### BACKGROUND

Various typical techniques for obtaining the resistance value of a wiring within a semiconductor circuit device have been presented.

### SUMMARY

In an aspect of the invention, a resistance value calculating method of a computer calculating a resistance value of a wiring of a semiconductor circuit device, the method includes dividing the wiring into rectangular regions each has an orthogonal coordinate system and are mutually not contained, drawing a first line segment up to a front of an edge portion of an overlapped region in which a first divided region and a second divided region overlap in a longitudinal direction of a center portion of the first region, drawing a second line segment in a longitudinal direction of a center portion of the second region after the first line segment is drawn, and calculating a resistance value of the first region and the second region in accordance with a length of each line segment and a width of each region.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIGS. 1A and 1B illustrate a technique for dividing a wiring.

FIGS. 2A and 2B illustrate a process for calculating a resistance value.

FIGS. 3A, 3B, 3C and 3D illustrate various wiring patterns.

FIG. 4 illustrates a computer system which operates as a resistance value calculating device according to an embodiment.

FIG. 5 illustrates a block diagram of a computer system according to an embodiment.

FIG. 6 illustrates a configuration of an electromigration analyzing device.

FIG. 7 illustrates an example of Annotated-GDS data.

FIG. 8 illustrates a wiring pattern represented with the Annotated-GDS data on an X-Y coordinates.

FIG. 9 illustrates a diagram representing a resistance value calculating method according to an embodiment.

FIG. 10 illustrates a diagram of drawing of a line segment using the resistance value calculating method according to an embodiment.

FIGS. 11A, 11B and 11C illustrate diagrams of dividing a wiring into multiple regions.

FIGS. 12A and 12B illustrate diagrams of setting a direction where a line segment is drawn and a width of the region.

FIGS. 13A, 13B, 13C, 13D and 13E illustrate a diagram of drawing a line segment according to a resistance value calculating method according to an embodiment.

FIGS. 14A, 14B, 14C, 14D, 14E and 14F illustrate width of a region.

FIG. 15 illustrates a via position.

FIG. 16 illustrates a processing unit of a resistance value calculating device according to an embodiment.

FIG. 17 is a flowchart illustrating resistance value calculation process according to an embodiment.

FIG. 18 is a diagram illustrating a data structure of a line segment according to an embodiment.

FIGS. 19A and 19B are diagrams illustrating a structure of resistance value data according to an embodiment.

FIGS. 20A, 20B, 20C, 20D, 20E and 20F are diagrams for describing how to draw a line segment.

FIGS. 21A, 21B, 21C, 21D and 21E are diagrams for describing how to draw a line segment.

FIGS. 22A, 22B, 22C and 22D are diagrams for describing how to draw a line segment.

FIGS. 23A, 23B, 23C, 23D, 23E and 23F are diagrams for describing how to draw a line segment.

FIGS. 24A, 24B and 24C are diagrams for describing how to draw a line segment.

### DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

An embodiment of the present invention will be described below.

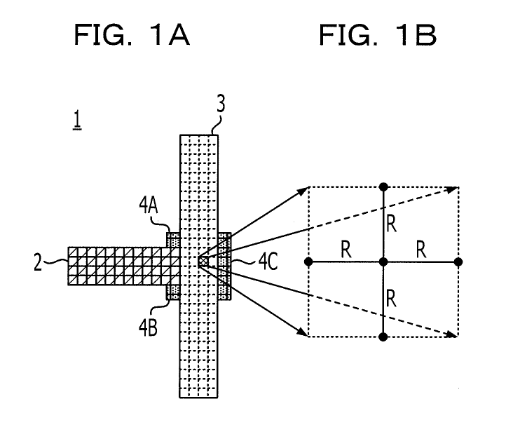

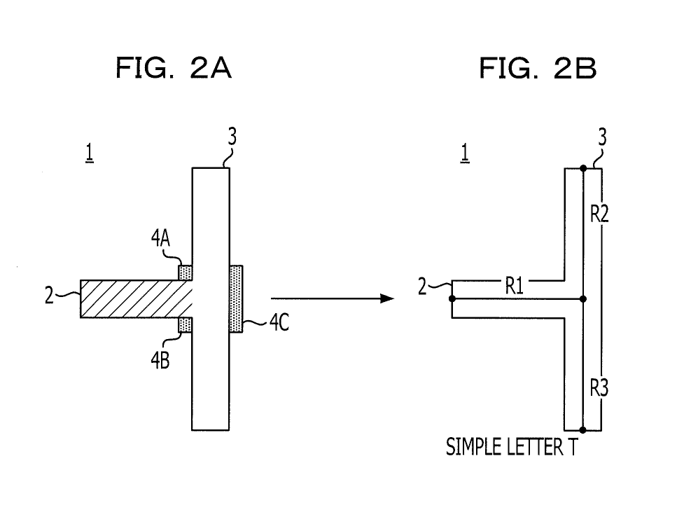

First, problems in a resistance value calculating method will be described with reference to FIGS. 1 and 2.

Upon current continuously flowing into a wiring of a semiconductor circuit device such as an LSI (Large Scale Integrated circuit) in one direction, electromigration in which the wiring is damaged by metal atoms moving within the wiring may occur.

Therefore, electromigration analysis is generally performed in a research and development stage or in a design stage of a semiconductor circuit device. In the electromigration analysis, a current amount flowing into the wiring is analyzed to verify whether or not the current amount exceeds a current threshold that may cause electromigration.

With the electromigration analysis, an extraction of a wiring of a semiconductor circuit device having a complicated shape as a resistor element may have an influence on the precision of analysis results and analysis time.

Wirings generally have fixed thickness. Accordingly, if the shape of a wiring is a simple rectangle with a plane view, the resistance value of the wiring may be calculated by “sheet resistance×wiring length÷wiring width”. Accordingly, the wiring is readily replaced with a resistor element.

However, an actual wiring has a complicated polygon including branches, bends, steps of wiring width, increase/decrease of wiring width, and so forth with a plane view. Accordingly, it is not easy to perform the electromigration analysis regarding an actual wiring.

With such electromigration analysis, the following two resistance value calculating methods are employed, for example.

FIG. 1A is a diagram illustrating a technique for dividing a wiring by a resistance value calculating method. FIG. 1B is a diagram illustrated by enlarging a portion of FIG. 1A.

As illustrated in FIG. 1A, with a wiring 1, a wiring portion 2 (portion with shading) and a wiring portion 3 (portion without shading) are connected in a T-letter shape, and connected portions between the wiring portion 2 and wiring portion 3 include protrusions 4A, 4B, and 4C. Such wiring 1 is divided into minute meshes indicated with dashed lines, and a resistor element R is assigned to each of gratings included in meshes as illustrated in FIG. 1B to obtain the entire resistance value of the wiring 1.

Next, another resistance value calculating method will be described with reference to FIG. 2.

FIGS. 2A and 2B are diagrams illustrating processing to be performed on a wiring with another resistance value calculating method. Note that, for convenience of description, the same wiring as the wiring 1 illustrated in FIG. 1A is illustrated in FIGS. 2A and 2B.

With the other resistance value calculating method illustrated in FIG. 2, for example, the shape of the wiring 1 is simplified by removing the protrusions 4A, 4B, and 4C of the wiring 1 illustrated in FIG. 1 as illustrated in FIG. 2B, and applying resistance values R1, R2, and R3 to the wiring portion 2 and wiring portion 3 of the simplified wiring 1, thereby obtaining the resistance value of the wiring 1.

With the above-mentioned resistance value calculating methods, a synthesized resistance value of minute resistance of each grating has been calculated by dividing the wiring into meshes, or a resistance value has been calculated regarding the wiring having a simplified shape.

However, with the method for calculating the synthesized resistance value of minute resistance of each grating by dividing the wiring into a mesh, the resistance value may be obtained with high precision, but a huge number of resistor elements are extracted, which results in a problem in that it takes a long time for the electromigration analysis. Also, this also has a problem in that as miniaturization advances the calculation amount increases.

Accordingly, in order to calculate the synthesized resistance value of minute resistance of each grating by dividing into meshes, it is not a realistic calculating method for solving simultaneous equations or an inverse matrix using a direct process.

With the electromigration analysis of a semiconductor circuit device of which the miniaturization has advanced, a calculation method for obtaining an approximate solution for the electric current by the iteration method or the like has been employed.

Also, with the technique for calculating a resistance value regarding a wiring having a simplified shape, upon miniaturization advancing, necessity to change the current threshold according to the electromigration analysis is caused, which results in a problem in that the calculation precision of a resistance value varies according to relationship between the current threshold and the minute steps of a wiring.

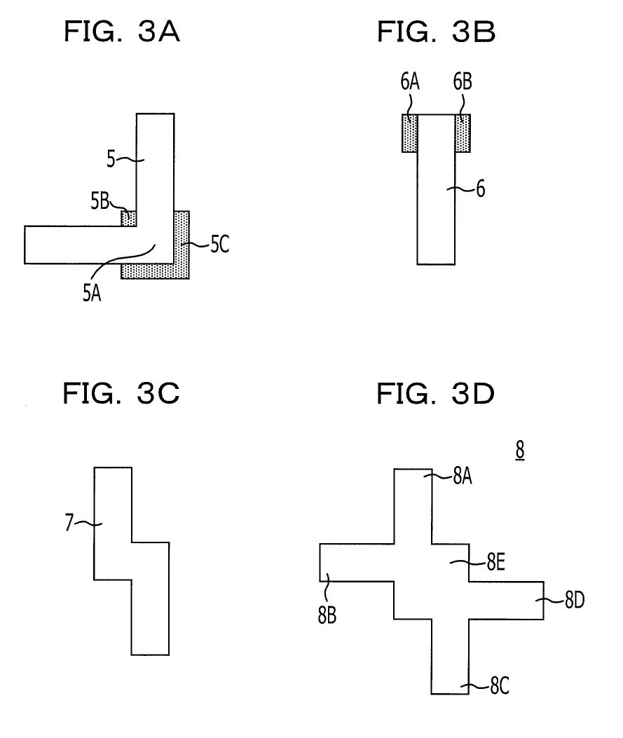

Also, an actual wiring has various patterns as illustrated in FIGS. 3A, 3B, 3C and 3D (3A to 3D). Examples of this include a pattern where protrusions 5B and 5C are formed on the inner side and outer side of a corner portion 5A of a wiring 5 as illustrated in FIG. 3A, and a pattern where protrusions 6A and 6B are formed on the edge portions of a linear wiring 6 as illustrated in FIG. 3B. Also, examples of this include a pattern bent in a crank shape such as a wiring 7 illustrated in FIG. 3C, and a pattern where there is a protrusion at a joint portion 8E of four wiring portions 8A to 8D of which the directions mutually differ like a wiring 8 illustrated in FIG. 3D, and so forth. An actual wiring has a pattern obtained by complicatedly combining the patterns in FIGS. 3A to 3D as a whole.

Applying the method for calculating a resistance value regarding a wiring having a simplified shape to such a complicated wiring pattern causes a problem in that the calculation precision of the resistance value deteriorates.

The above-mentioned resistance value calculating methods have a problem such as taking a long time for the electromigration analysis, increase in the calculation amount, variation of precision in calculation of a resistance value, deterioration in precision, and so forth.

A resistance value calculating device according to an embodiment is described below in detail.

Hereafter, description is made in detail regarding a resistance value calculating method that is executed by a computer system which operates as a resistance value calculating device into which a resistance value calculating program is installed.

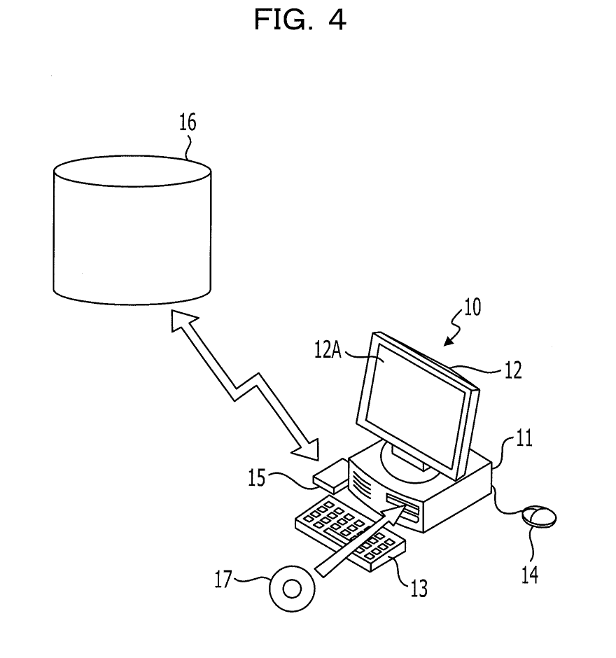

FIG. 4 illustrates a computer system implemented with an electromigration analyzing device including a resistance value calculating device according to an embodiment. A computer system 10 illustrated in FIG. 4 includes a main unit 11, a display 12, a keyboard 13, a mouse 14, and a communication unit 15.

The main unit 11 houses a CPU (Central Processing Unit), an HDD (Hard Disk Drive), a disc drive, and so forth. The display 12 is a display unit for displaying analysis results and so forth on a display screen 12A by a command that the CPU within the main unit 11 generates, and a liquid crystal monitor may be employed. The keyboard 13 is an input unit for inputting various types of information to the computer system 10. The mouse 14 is an input unit for specifying an optional position on the display screen 12A of the display 12. The communication unit 15 accesses an external database or the like to download a program and so forth stored in another computer system.

An electromigration analyzing program and a resistance value calculating program of the computer system 10 executing an operation including an electromigration analysis processing and resistance value calculation processing may be stored in a portable recording medium such as a disc 17 or the like, or downloaded from a recording medium 16 of another computer system using the communication unit 15.

The electromigration analyzing program operates the CPU of the computer system 10 as an electromigration analyzing device.

The resistance value calculating program may be a part of the electromigration analyzing program, or may be another program separately from the electromigration analyzing program. The resistance value calculating program operates the CPU of the computer system 10 as a resistance vale calculating device.

The electromigration analyzing program and resistance value calculating program are stored in a computer-readable recording medium, for example, such as the disc 17 or the like. The computer-readable recording medium is not restricted to a portable recording medium, such as IC card memory, a magnetic disk such as a floppy disk (registered trademark) or the like, a magneto-optical disk, CD-ROM, and so forth, and includes various types of recording media which a computer system which is connected via the communication unit 15 or a communication device such as a LAN or the like may access.

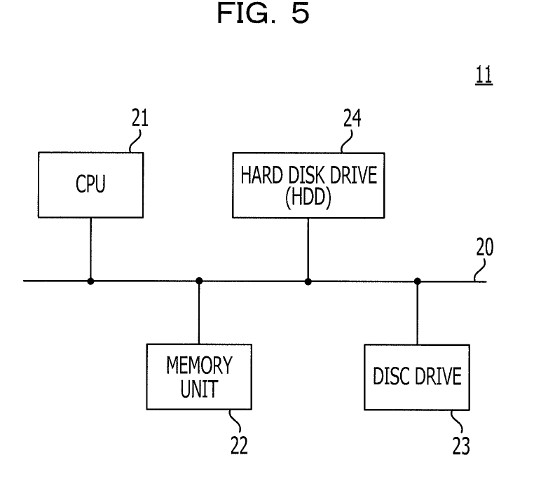

FIG. 5 is a block diagram illustrating principal portions within the main unit 11 of the computer system 10. The main unit 11 includes a CPU 21, a memory unit 22 including RAM or ROM or the like, a disc drive 23 for the disc 17, and a hard disk drive 24, which are connected by a bus 20.

Note that the computer system 10 is not restricted to those illustrated in FIGS. 4 and 5, and various known elements may be added thereto, or may alternatively be employed.

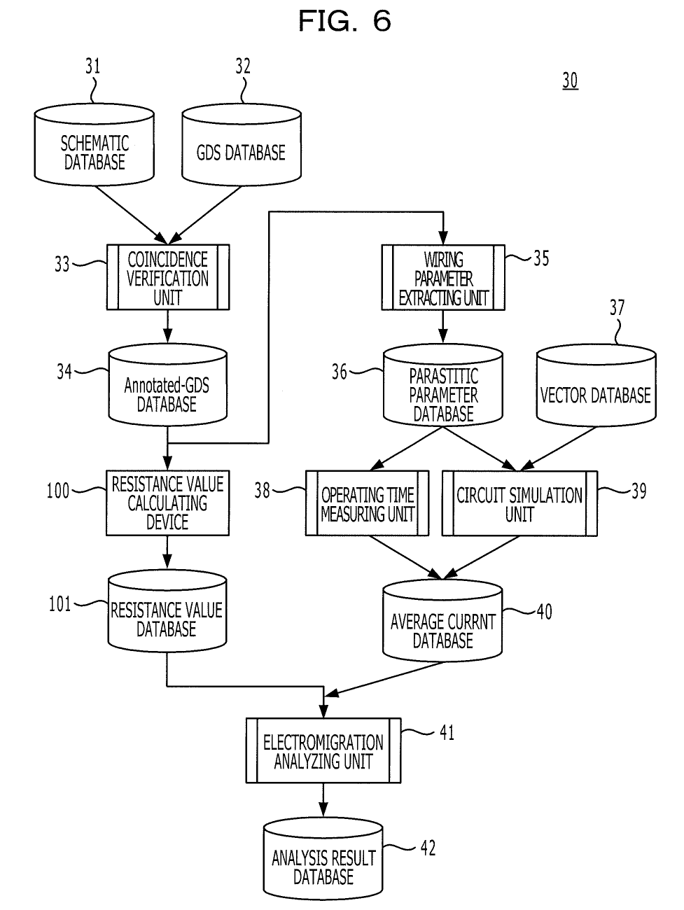

Next, the configuration of a processing unit included in the electromigration analyzing device including the resistance value calculating device, and the flow of data processing is described in detail with reference to FIG. 6.

FIG. 6 is a diagram illustrating the electromigration analyzing device including a resistance value calculating device according to an embodiment.

An electromigration analyzing device 30 includes a schematic database 31, a GDS database 32, a coincidence verification unit 33, an Annotated-GDS database 34, a resistance value calculating device 100, and a resistance value database 101. Also, the electromigration analyzing device 30 further includes a wiring parameter extracting unit 35, a parasitic parameter database 36, a vector database 37, an operating time measuring unit 38, a circuit simulation unit 39, an average current database 40, an electromigration analyzing unit 41, and an analysis result database 42.

The schematic database 31 is a database storing the (schematic) data of a wiring correlated with a part name, terminal name, and net name included in the semiconductor circuit device.

The GDS database 32 is a database storing data representing a mask pattern. Here, GDS (Graphic Data System) means a data format for determining the layout of an LSI. Data representing a mask pattern is stored in the GDS database 32 in a GDS format.

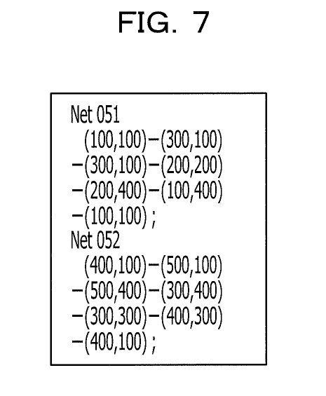

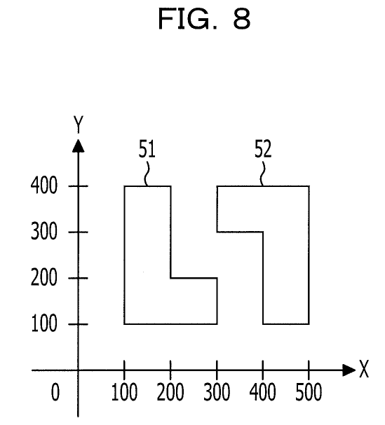

The coincidence verification unit 33 verifies coincidence between the data of a wiring stored in the schematic database 31, and the data representing a mask pattern stored in the GDS database 32, and outputs Annotated-GDS data that is binary-formatted data where the net number of the wiring and GDS-formatted data are correlated. For example, Calibre LVS (Layout Versus Schematic) may be employed as the coincidence verification unit 33. Detailed description is provided below regarding the Annotated-GDS data with reference to FIGS. 7 and 8.

The Annotated-GDS database 34 stores the Annotated-GDS data.

The resistance value calculating device 100 is a device which uses the Annotated-GDS data stored in the Annotated-GDS database 34 to calculate a resistance value of a wiring of the semiconductor circuit device. The processing content of the resistance value calculating device 100 is described in detail below.

The resistance value database 101 is a database which stores resistance value data representing the resistance value that the resistance value calculating device 100 calculates. The resistance value is described in detail below.

The wiring parameter extracting unit 35 uses the resistance value data that the resistance value database 101 stores to extract parasitic parameters that are the values of parasitic resistance and parasitic capacity include in a wiring. Star-RCXT for LPE (Layout parameter extraction) may be employed as the wiring parameter extracting unit 35, for example.

The parasitic parameter database 36 stores the parasitic parameters extracted by the wiring parameter extracting unit 35.

The vector database 37 stores a vector file where the expected values of an input waveform and an output waveform are described in the time sequence.

The operating time measuring unit 38 uses the parasitic parameters stored in the parasitic parameter database 36 to measure rise time Tr and fall time Tf in the operation of the semiconductor circuit device, and calculates an average current.

The circuit simulation unit 39 uses the parasitic parameters stored in the parasitic parameter database 36, and the vector file stored in the vector database 37 to calculate an average current flowing into the wiring. Ultra Sim may be employed as the circuit simulation unit 39, for example.

The average current database 40 stores the average current calculated by the operating time measuring unit 38 or the average current data representing the average current calculated by the circuit simulation unit 39.

The electromigration analyzing unit 41 uses the resistance value data stored by the resistance value database 101, and the average current data stored by the average current database 40 to execute electromigration analysis.

The analysis result database 42 stores the analysis results of the electromigration analyzing unit 41.

Note that the coincidence verification unit 33, resistance value calculating device 100, a wiring parameter extracting unit 35, operating time measuring unit 38, circuit simulation unit 39, and electromigration analyzing unit 41 are realized by the CPU 21 of the computer system 10 illustrated in FIG. 5 executing the program.

Also, the schematic database 31, GDS database 32, Annotated-GDS database 34, resistance value database 101, parasitic parameter database 36, vector database 37, average current database 40, and analysis result database 42 are stored in the HDD 24 illustrated in FIG. 5.

Next, the Annotated-GDS data is described in detail with reference to FIGS. 7 and 8.

FIG. 7 is an example of the Annotated-GDS data indicating coordinates of an apex of a wiring used for a resistance value calculating method according to an embodiment.

FIG. 8 is a diagram illustrating a wiring pattern represented with the Annotated-GDS data in FIG. 7 on the X-Y coordinates. Wiring patterns illustrated in FIG. 8 represent a wiring in a shape with a plane view.

As described above, GDS is a data format for determining a layout of an LSI, and typically used as a data format of data representing a mask pattern.

Also, the Annotated-GDS data is binary-formatted data where the net number of a wiring, and GDS-formatted data are correlated. In addition to the data representing the coordinates of a wiring, data representing the coordinates of a via is included in the Annotated-GDS data.

In FIG. 7, the Annotated-GDS data originally represented by a binary format is represented by a text format. The Annotated-GDS data illustrated in FIG. 7 is the Annotated-GDS data of a wiring 51 and a wiring 52 illustrated in FIG. 8.

The Annotated-GDS data represents the X-Y coordinates (X, Y) of an apex included in a wiring by being arrayed in a clockwise or counterclockwise direction from the coordinates.

Accordingly, the Annotated-GDS data of the wiring 51 (Net 051) illustrated in FIG. 8 is represented as (100, 100)-(300, 100)-(300, 200)-(200, 200)-(200, 400)-(100, 400)-(100, 100) as illustrated in FIG. 7. The reason why the first and last coordinates are the same (100, 100) is because the wiring 51 is gone around in the counterclockwise direction and closed.

Similarly, the Annotated-GDS data of the wiring 52 (Net 052) illustrated in FIG. 8 is represented as (400, 100)-(500, 100)-(500, 400)-(300, 400)-(300, 300)-(400, 300)-(400, 100) as illustrated in FIG. 7.

The net 051 and net 052 represent the net number of a wiring.

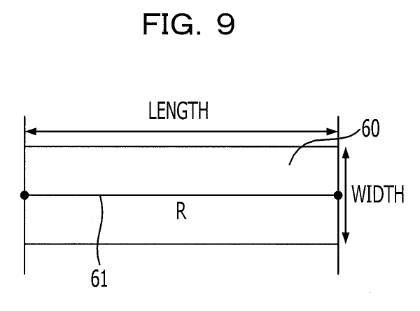

Next, a method for calculating a resistance value is described in detail with reference to FIG. 9.

As a wiring of a semiconductor circuit device such as an LSI, a metal wiring such as copper or aluminum or the like is employed, for example. Such metal wiring has generally fixed thickness.

A resistance value R of a wiring of which the thickness is fixed is obtained by sheet resistance×wiring length÷wiring width, but an actual wiring has a complicated pattern, and accordingly, with an embodiment, a wiring having a complicated pattern is divided into multiple rectangular regions under a certain rule, and a resistance value is calculated for each region.

Also, let us say that one of the multiple regions obtained by diving the wiring under a certain rule is a region 60 illustrated in FIG. 9.

An actual wiring has a complicated pattern, and particularly, it is difficult to define the length and width for obtaining a resistance value at a connected portion between regions, and accordingly, with an embodiment, a line segment 61 representing a resistance component is drawn on a symmetric axis I in the longitudinal direction of the region 60.

The length of the line segment 61 is determined by a connection relation and a position relation with a region around the region 60. Also, the width of the region 60 where the line segment 61 is drawn is determined under a certain rule.

Subsequently, the length of the line segment 61, and the width of the region 60 where the line segment 61 is drawn are used to calculate the resistance value of the region 60 by sheet resistance×wiring length÷wiring width.

With an embodiment, the line segment 61 whereby the resistance value is obtained as described above is handled as the resistor element of the resistance value R.

Hereafter, how to draw a line segment and how to obtain a resistance value in the resistance value calculating method is described in detail.

Note that a line segment representing a resistance component will simply be referred to as “line segment” in some cases.

With the resistance value calculating method according to an embodiment, the length of a line segment representing a resistance component, and the width of the region are obtained in accordance with the following rules, and calculates a resistance value.

1. According to an embodiment, a wiring is divided into multiple rectangular regions that are mutually not contained. Any one of the divided regions that is self-contained may have a portion thereof that overlaps with a portion of another self-contained region.

Regions that are mutually not contained are regions where an entirety of a region is not contained in another region. Accordingly, the rectangular regions that are mutually not contained may include a portion of another rectangular region. That is to say, the rectangular regions that are mutually not contained may include a region overlapped with another rectangular region.

2. Regarding each of the regions, a direction where a line segment is drawn is set to a longitudinal direction, and a width of the region is set to a transversal direction.

A line segment is drawn on the symmetric axis in a longitudinal direction of the symmetric axes in the longitudinal direction and transversal direction of a rectangular region. Also, a line segment is drawn from one edge of a region to the other edge as long as a drawing margin is set by the rule 4, and accordingly, the coordinates of both edges of the line segment become the coordinates of a midpoint of the shorter side of the region. Note that in the event that the region is a regular square, a direction where a line segment is drawn is set to the Y-axis direction, and the side in the X-axis direction is taken as the shorter side.

3. The rank order for drawing a line segment as to the multiple regions generated by the rule 1 is the rank order from a wider region to a narrower region, according to an embodiment.

4. In the event that there is a region overlapped with another region on a shorter side including the edge points of a line segment, a drawing margin is set to the line segment.

The drawing margin is a portion where the edge points of a line segment is offset to reduce the line segment, and the length thereof is a half of the width W of another region overlapped with the own region (W/2). Note that the coordinate values represented by the Annotated-GDS data are integers, and accordingly, the value of the width W is also an integer. With an embodiment, let us say that in the event that the value of the width W is an odd number, below a decimal point will be omitted. Note that coordinate values with below a decimal point being not omitted may be employed.

5. In the event of drawing a line segment regarding a region of which the rank order is the second region and thereafter, when there is a line segment already drawn on another region having a region overlapped with the region being processed now, and if a line segment is drawn on the region being processed now, when an overlap occurs with a line segment already drawn regarding another region in the direction of drawing the line segment, crank connection is performed.

The crank connection means that a line segment is not drawn on the region being processed now regarding a section where an overlap occurs, and an edge portion of the section where no line segment is drawn is orthogonally bent to connect a line segment already drawn on another region in a crank shape.

6. The width of a region used for obtaining the resistance value of each line segment is set to the width set in the rule 2.

With regard to the portion where the line segment has been bent for crank connection, the width of the region including the line segment of the bent portion is set.

7. In the event that the center of a via is not positioned on a line segment, the center position of the via is shifted onto the line segment.

According to the above-mentioned rule 1 to rule 7, the resistance values of all of the wirings of the semiconductor circuit device are obtained for each line segment.

The resistance value for each line segment is held as table data in a determinant format.

Next, how to draw a line segment in accordance with the above-mentioned rules is described in detail with reference to FIGS. 10, 11A, 11B, 11C, 12A, 12B and 13A, 13B, 13C, 13D and 13E.

FIG. 10 is a diagram for describing how to draw a line segment by the resistance value calculating method according to an embodiment.

The Annotated-GDS data of the wiring 70 illustrated in FIG. 10 is (200, 100)-(300, 100)-(300, 400)-(400, 400)-(400, 700)-(300, 700)-(300, 1000)-(200, 1000)-(200, 100).

As illustrated in FIG. 10, a straight line passing through each apex will be defined. Let us say that straight lines represented by X=200, 300, and 400 are taken as L1, L2, and L3 respectively, and straight lines represented by Y=100, 400, 700, and 1000 are taken as L4, L5, L6, and L7 respectively. The wiring 70 is divided into four rectangles by the straight lines L1 to L3, and L4 to L7.

As illustrated in FIG. 10, let us say that the apexes of the rectangles divided by the straight lines L1 to L3, and L4 to L7 are taken as apexes A, B, C, D, E, F, G, H, I, and J.

Next, the above-mentioned rule 1 is applied to the wiring 70 illustrated in FIG. 10 to divide the wiring 70 into multiple rectangular regions that are mutually not contained.

In order to divide the wiring 70 into multiple regions in accordance with the rule 1, first, the wiring 70 having a polygonal pattern is divided into multiple rectangular regions that are mutually not contained.

Regarding all of the rectangles divided by the straight lines L1 to L3, and L4 to L7, multiple rectangular regions that are mutually not contained are searched with the following manner.

(1-1) Rectangles ABDC, ABGF, CDJI, and FGJI are contained in a rectangle ABJI.
(1-2) A rectangle CDGF is contained in the rectangle ABJI and a rectangle CEHF.
(1-3) A rectangle DEHG is contained in the rectangle CEHF.
(1-4) The rectangle ABJI and rectangle CEHF are not contained in neither of other rectangles.

Thus, of the rectangular regions included in the wiring 70, the multiple rectangular regions that are mutually not contained are the rectangle ABJI and rectangle CEHF.

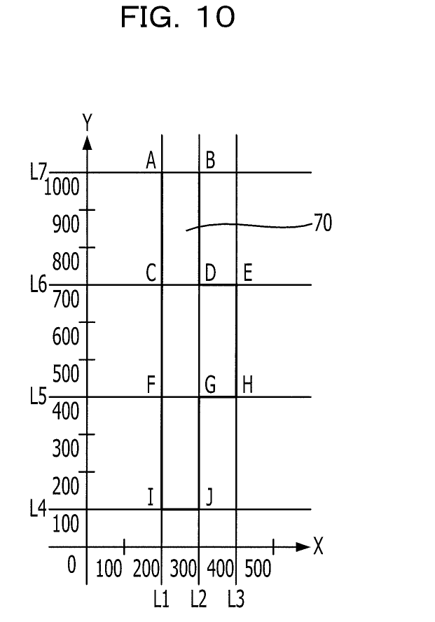

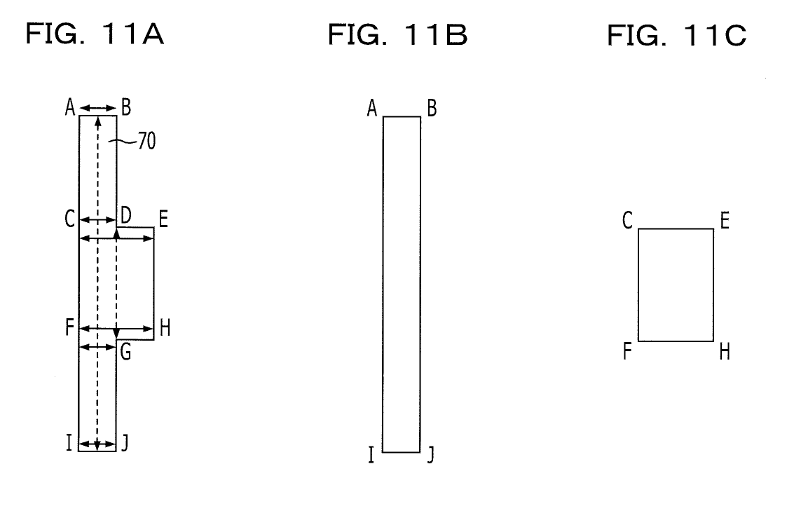

As described above, several techniques for dividing a wiring into multiple rectangular regions that are mutually not contained may be conceived, but with an embodiment, this will be performed by the technique illustrated in FIGS. 11A, 11b and 11C (11A to 11C).

With description in FIGS. 11A to 11C, a line segment included in the pattern of a wiring is employed, but a line segment in FIGS. 11A to 11C differs from a line segment representing a resistance component, and is a line segment connecting apexes of a polygon representing the pattern of a wiring.

FIGS. 11A to 11C are diagrams for describing a method for dividing the wiring 70 into multiple regions in accordance with the rule 1.

With an embodiment, attention is focused on all of the apexes A to J included in the wiring 70 illustrated in FIG. 11A, a line segment between the apexes of the wiring 70 having a pattern represented by a polygon ABDEHGJI is scanned in the X-axis direction and Y-axis direction, thereby obtaining multiple rectangular regions that are mutually not contained.

(2-1) Upon scanning a line segment AB in the negative direction of the Y axis, scanning reaches from the line segment AB to a line segment IJ, thereby obtaining a rectangle ABJI.

(2-2) Upon scanning a line segment CD in the positive direction and negative direction of the Y axis, scanning is performed from the line segment AB to the line segment IJ, thereby obtaining the rectangle ABJI. However, extraction of the rectangle ABJI has already been performed by the processing in (2-1). Note that this is also applied to line segments FG and U.

(2-3) Upon scanning a line segment CE in the negative direction of the Y axis, scanning reaches from the line segment CE to a line segment FH, thereby obtaining a rectangle CEHF. Note that this is also applied to the line segment FH.

Even if the Y axis in (2-1) to (2-3) is replaced with the X axis, the same results may be obtained.

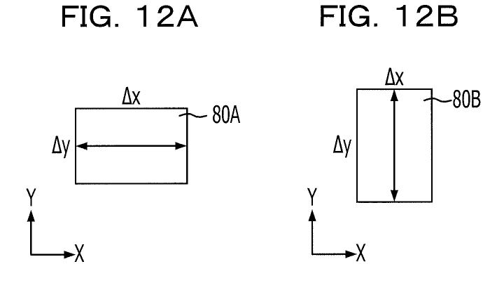

Processing in accordance with the rule 2 is described in detail with reference to FIGS. 12A and 12B. With the rule 2, a direction where a line segment representing a resistance component is drawn on a region, and the width of the region are set.

FIGS. 12A and 12B are diagrams for describing a method for setting a direction where a line segment representing a resistance component is drawn on a region, and the width of the region in accordance with the rule 2.

As described above, with the rule 2, a direction where a line segment representing a resistance component is drawn is set to the longitudinal direction, and the width of the region is set to the transversal direction.

Like the region 80A illustrated in FIG. 12A, in the event that, regarding side length Δx in the X-axis direction, and side length Δy in the Y-axis direction, Δx>Δy holds, this is a case where the longitudinal direction of the region 80A faces the X-axis direction. In such a case, the direction where a line segment is drawn is set to the longitudinal direction (X-axis direction), and the width for obtaining the resistance value of the region 80A is set to the side length Δy in the transversal direction (Y-axis direction).

Note that the side length Δx in the X-axis direction, and the side length Δy in the Y-axis direction may be obtained from the coordinate values of the apexes of the region 80A.

Also, like the region 80B illustrated in FIG. 12B, in the event that, regarding side length Δx in the X-axis direction, and side length Δy in the Y-axis direction, Δx<Δy holds, this is a case where the longitudinal direction of the region 80B faces the Y-axis direction. In such a case, the direction where a line segment is drawn is set to the longitudinal direction (Y-axis direction), and the width for obtaining the resistance value of the region 80B is set to the side length Δx in the transversal direction (X-axis direction).

With an embodiment, in the event that the region is a regular square, the direction where a line segment is drawn is set to the Y-axis direction, and the width for obtaining the resistance value of the region is set to the side length Δx in the X-axis direction.

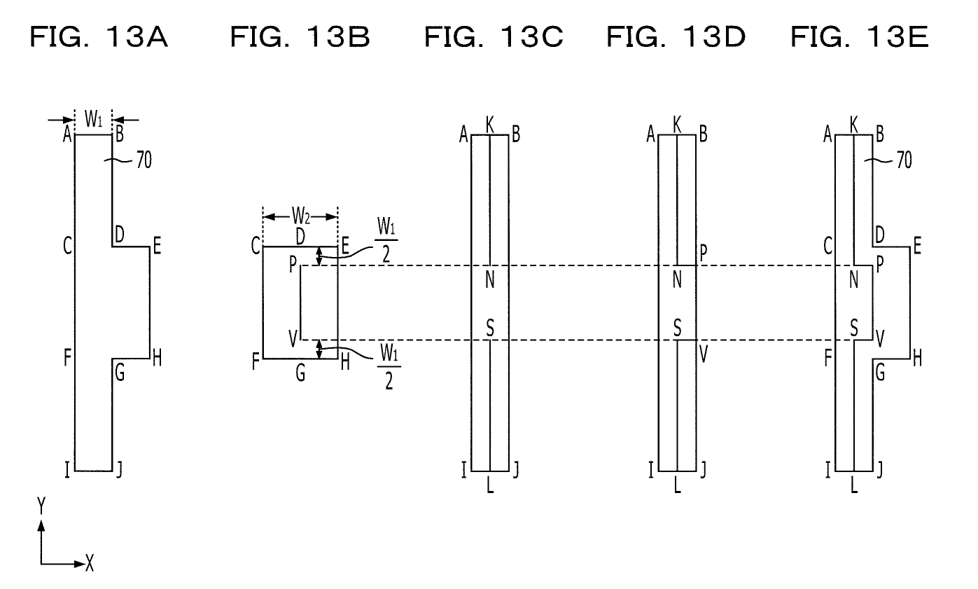

Next, how to draw a line segment is described in detail with reference to FIG. 13.

FIG. 13 is a diagram illustrating how to draw a line segment by the resistance value calculating method according to an embodiment in a stepwise manner.

The wiring 70 illustrated in FIG. 13A is a wiring having the same pattern as the wiring 70 illustrated in FIG. 10 and FIGS. 11A to 11C. Accordingly, the wiring 70 is divided into the multiple rectangular regions ABJI and region CEHF that are mutually not contained, in accordance with the rule 1.

With the rule 2 according to an embodiment, the direction where a line segment is drawn is set to the longitudinal direction of the region, and the width for obtaining the resistance value of the region is set to the side length in the transversal direction of the region.

With the region ABJI, the Y-axis direction is the longitudinal direction, and the X-axis direction is the transversal direction, and accordingly, a line segment is draw in the Y-axis direction, and the width of the region ABJI is the length W₁ of a side AB. Both edges of the line segment to be drawn on the region ABJI are the midpoint of the side AB, and the midpoint of a side IJ.

With the region CEHF, the Y-axis direction is the longitudinal direction, and the X-axis direction is the transversal direction, and accordingly, a line segment is draw in the Y-axis direction, and the width of the region CEHF is the length W₂ (>W₁) of a side CE. Both ends of the line segment to be drawn on the region CEHF are edge points determined by the rule 4.

With regard to determination regarding the longitudinal direction and transversal direction of the region ABJI and region CEHF, determination may be made based on the apex coordinates of each region which is longer of the side in the X-axis direction and the side in the Y-axis direction of the rectangular region.

The coordinates of both edges of a line segment to be drawn on each region may be obtained as the midpoint of a pair of the short sides of each region.

With the rule 3 according to an embodiment, a line segment is drawn sequentially from a wider region determined in the rule 2 regarding the region ABJI and region CEHF obtained in the rule 1.

As described above, with the region ABJI and region CEHF, the width W₂ of the region CEHF is wider than the width W₁ of the region ABJI, and accordingly, with regard to the region ABJI and region CEHF, a line segment is drawn in the order of the region CEHF and region ABJI.

In this way, with regard to the rank order to draw a line segment, a line segment is drawn in order from a wider region determined in the rule 2, and accordingly, a line segment may be drawn in order from a region having a longer short side length by comparing the short side length of each region.

With the wiring 70 illustrated in FIG. 13, first, a line segment is drawn on the region CEHF. In the case of the region CEHF, both edges of a line segment set by the rule 2 are points D and G illustrated in FIG. 13B. The point D is the midpoint of the side CE that is one of the short sides, and the point G is the midpoint of the side FH that is the other short side. That is to say, according to the rule 2, with regard to the region CEHF, a line segment DG is drawn on the symmetric axis in the longitudinal direction of the region CEHF.

However, with regard to the short side CE including the edge point D of the line segment DG, as illustrated in FIG. 13A, the region ABJI is overlapped.

Therefore, according to the rule 4, a drawing margin has to be provided to the edge pint D of the line segment DG in FIG. 13B. The length of the drawing margin used for the edge point D of the line segment DG is, according to the rule 4, the length of a half of the width W₁ (W₁/2) of the other region ABJI overlapped with the own short side CE.

Accordingly, the line segment DG is reduced, as illustrated in FIG. 13B, by the drawing margin (W₁/2) at the edge point D, up to a point P.

Also, with a short side FH including a point G, as illustrated in FIG. 13A, the region ABJI is overlapped.

Therefore, according to the rule 4, a drawing margin has to be provided to the edge pint G of the line segment DG in FIG. 13B. The length of the drawing margin used for the edge point G of the line segment DG is, according to the rule 4, the length of a half of the width W₁ (W₁/2) of the other region ABJI overlapped with the own short side FH.

Accordingly, the line segment DG is reduced, as illustrated in FIG. 13B, by the drawing margin (W₁/2) at the edge point G, up to a point V.

Thus, with the region CEHF, the line segment PV is drawn on the symmetric axis in the longitudinal direction.

Next, a line segment is drawn on the region ABJI. In the case of the region ABJI, both edges of the line segment set in accordance with the rule 2 are points K and L illustrated in FIG. 13C. The point K is the midpoint of the side AB, and the point L is the midpoint of the side U. That is to say, according to the rule 2, with the region ABJI, the line segment KL is drawn on the symmetric axis in the longitudinal direction of the region ABJI.

With the short side AB including the edge point K of the line segment KL, as illustrated in FIG. 13A, another region is not overlapped.

Accordingly, the rule 4 does not apply to the edge point K of the line segment KL, and accordingly, no drawing margin has to be provided.

Also, with the short side IJ including the edge point L of the line segment KL, as illustrated in FIG. 13A, another region is not overlapped.

Accordingly, the rule 4 does not apply to the edge point L of the line segment KL, and accordingly, no drawing margin has to be provided.

Next, the rule 5 is applied to the region ABJI since the rank order to draw a line segment is the second and thereafter.

Upon drawing the line segment KL, an overlap in the Y-axis direction is caused with the already drawn line segment PV of the other region CEHF (FIG. 13C), and accordingly, of the line segment KL, no line segment is drawn regarding a section NS of which the Y-axis coordinate is the same as that of the line segment PV, and the line segment KN and line segment SL are subjected to crank connection as to the line segment PV.

As illustrated in FIG. 13D, in order to perform crank connection, a line segment NS is folded in the positive direction of the X axis at a point N to connect to a point P. Also, the line segment NS is folded in the positive direction of the X axis at a point S to connect to a point V.

In this way, upon performing crank connection, with regard to the wiring 70, as illustrated in FIG. 13E, the five of the line segment KN, line segment NP, line segment PV, line segment VS, and line segment SL are obtained. The line segment KN, line segment NP, line segment PV, line segment VS, and line segment SL are connected in this order.

The line segment KN, line segment NP, line segment PV, line segment VS, and line segment SL represent resistance components regarding the wiring 70.

In the event of calculating the resistance value of the wiring 70 using the line segment KN, line segment NP, line segment PV, line segment VS, and line segment SL, the length of each line segment is used as the length of resistance.

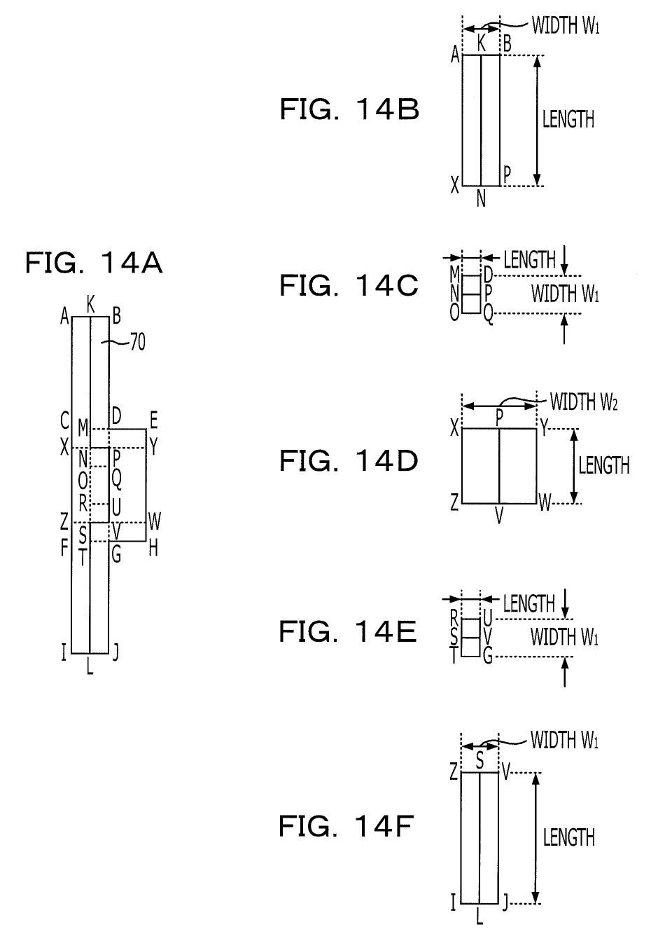

Next, description will be made regarding the width of a region used for calculating a resistance value using the line segment KN, line segment NP, line segment PV, line segment VS, and line segment SL representing the resistance components of the wiring 70, with reference to FIGS. 14A, 14B, 14C, 14D, 14E and 14F (14A to 14F).

FIGS. 14A to 14F are diagrams illustrating the width of a region in the resistance value calculating method according to an embodiment.

The wiring 70 illustrated in FIG. 14A is the same as the wiring 70 illustrated in FIGS. 13A and 13E, but for convenience of description, points M, O, Q, R, T, U, X, Y, Z, and W, and a straight line connecting each point are added.

FIGS. 14B to 14F represent the lengths of the five of the line segment KN, line segment NP, line segment PV, line segment VS, and line segment SL obtained regarding the wiring 70, and the width of a region including each line segment.

As illustrated in FIG. 14B, with regard to a line segment KN, the length serving as a resistance component is the length of the line segment KN, and the width of the region including the line segment KL is W₁. The line segment KN is a part of the line segment KL, and accordingly, the width of the region including the line segment KN is set to the width W₁ of the region ABJI including the line segment KL in accordance with the rule 6.

As illustrated in FIG. 14C, with regard to the line segment NP subjected to crank connection, the length serving as a resistance component is the length of the line segment NP, and the width of the region is W₁. The line segment NP is a line segment generated by folding the line segment NS to connect to the point P since an overlap is caused regarding the line segment NS of the line segment KL in accordance with the rule 5.

Accordingly, the width of the region including the line segment NP is set to the width W₁ of the region ABJI including the line segment NS serving as the source of the line segment NP before performing crank connection in accordance with the rule 6.

As illustrated in FIG. 14D, with regard to the line segment PV, the length serving as a resistance component is the length of the line segment PV. Also, the line segment PV is a line segment generated by offsetting both edges of the line segment DG of the region CEHF according to the drawing margin of the rule 4, and accordingly, the width of the region including the line segment PV is set to the width W₂ of the region CEHF including the line segment DG serving as the source of the line segment PV.

As illustrated in FIG. 14E, with regard to the line segment SV subjected to crank connection, the length serving as a resistance component is the length of the line segment SV, and the width of the region is W₁. The line segment SV is a line segment generated by folding the line segment NS to connect to the point V since an overlap is caused regarding the line segment NS of the line segment KL in accordance with the rule 5.

Accordingly, the width of the region including the line segment SV is set to the width W₁ of the region ABJI including the line segment SN serving as the source of the line segment of the SV before performing crank connection in accordance with the rule 6.

As illustrated in FIG. 14F, with regard to the line segment SL, the length serving as a resistance component is the length of the line segment SL, and the width of the region is W₁. The line segment SL is a part of the line segment KL, and the width of the region including the line segment SL is set to the width W₁ of the region ABJI including the line segment KL in accordance with the rule 6.

As described above, with regard to the wiring 70, the lengths of the line segments, and the widths of the regions illustrated in FIGS. 14B to 14F are obtained.

With the above-mentioned resistance value calculating method, the lengths and region widths of the obtained line segments are used to calculate the resistance value of the wiring 70 by sheet resistance×line segment length÷region width.

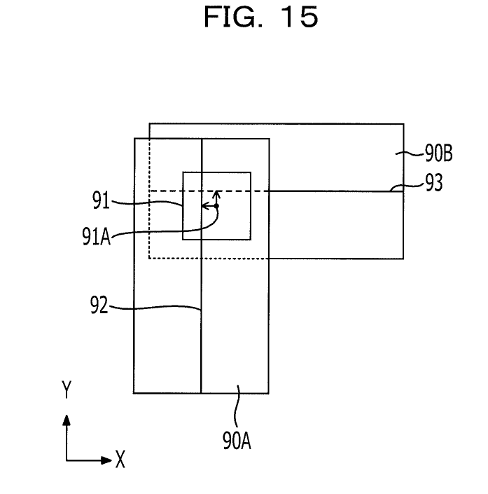

Next, via a position adjustment is described in detail with reference to FIG. 15.

FIG. 15 is a diagram illustrating a via position adjustment technique in accordance with the rule 7.

A semiconductor circuit device such as an LSI includes a multilayer wiring, and a via is employed for connection between layers. A via 91 is manufactured, for example, by aluminum or copper, and performs inter layer connection between an upper layer wiring 90A and a lower layer wiring 90B.

FIG. 15 illustrates a position relation alone between the upper layer wiring 90A, lower layer wiring 90B, and via 91 with a plane view, and drawing of an inter layer insulating film is omitted. Also, of the lower layer wiring 90B, a portion becoming the shade of the upper layer wiring 90A is illustrated with a dashed line.

Let us say that a line segment 92 is drawn on the upper layer wiring 90A, and a line segment 93 is drawn on the lower layer wiring 90B.

With the resistance value calculating method according to an embodiment, in the event that the center 91A of the via 91 is not positioned on the line segments 92 and 93, in accordance with rule 7 the position of the via 91 is shifted so that the center 91A is positioned on the line segments 92 and 93.

Note that the coordinates of the four apexes of the rectangular via 91 connected to the upper layer wiring 90A and the lower layer wiring 90B are included in the Annotated-GDS data. Accordingly, the coordinates of the four apexes may be adjusted so that the center 91A of the via 91 is positioned on the line segments 92 and 93.

The direction where the via 91 is moved may be the X-axis direction or Y-axis direction indicated with an arrow in FIG. 15, or either direction, as long as the via 91 may be moved on the nearest line segment. The nearest line segment may be obtained based on the coordinates of the center of the via 91 included in the Annotated-GDS data, and the coordinates of both edges of a line segment.

Adjustment of the position of the via 91 may be realized by moving the upper layer edge point and the lower layer edge point of the resistance representing the via 91 independently in the X-axis direction or Y-axis direction.

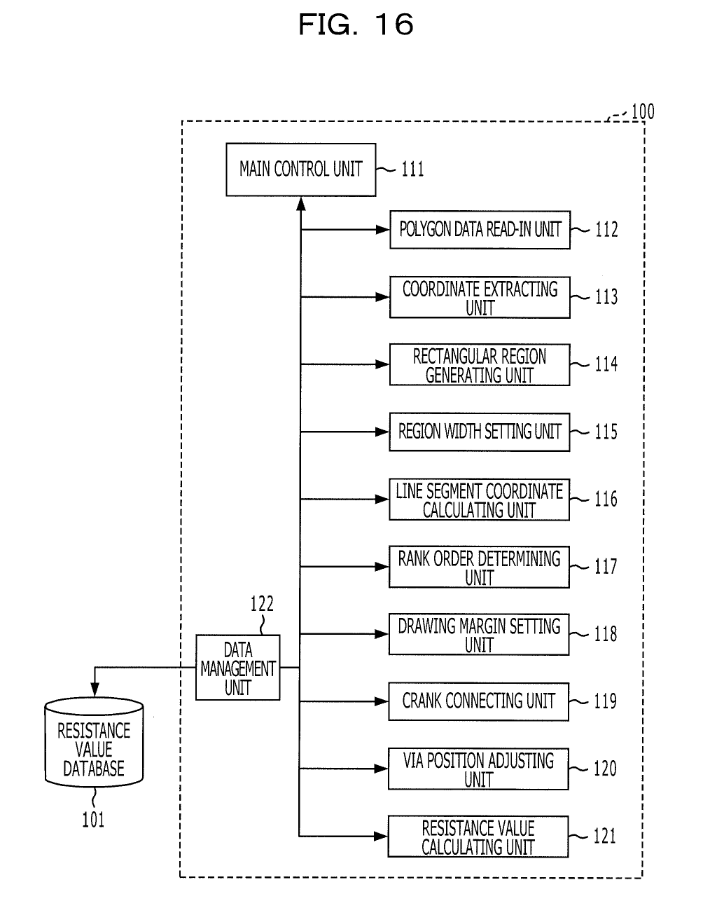

Next, the resistance value calculating device according to an embodiment is described in detail with reference to FIG. 16.

FIG. 16 is a block diagram illustrating a processing unit included in the resistance value calculating device 100. The processing unit illustrated in FIG. 16 is realized by the CPU 21 within the computer system 10 (see FIG. 5), for example, executing the resistance value calculating program stored in the HDD 24.

The processing unit realized by execution of the resistance value calculating program includes a main control unit 111, a polygon data read-in unit 112, a coordinate extracting unit 113, a rectangular region generating unit 114, a region width setting unit 115, a line segment coordinate calculating unit 116, a rank order determining unit 117, a drawing margin setting unit 118, a crank connecting unit 119, a via position adjusting unit 120, a resistance value calculating unit 121, and a data management unit 122.

The main control unit 111 controls each of the polygon data read-in unit 112 through the data management unit 122 to integrate processing.

The polygon data read-in unit 112 reads in polygon data included in the Annotated-GDS data. The polygon data is data representing the shapes (polygons) of all of the wirings included in the semiconductor circuit device, and is data in which the coordinates of all of the apexes included in polygons are arrayed from an apex close to the origin in the counterclockwise rotation in the X-Y coordinates. Examples of the polygon data include data in which the coordinates of each apex of the polygon ABDEHGJI representing the shape of the wiring 70 illustrated in FIG. 10 are arrayed in this order. The polygon data is provided with one data as to one wiring.

The coordinate extracting unit 113 performs processing for extracting the coordinates of all of the apexes include in the polygon data which the polygon data read-in unit 112 read in. For example, in the event of the polygon ABDEHGJI illustrated in FIG. 10, all of the X coordinate values and Y coordinate values included in the apexes A, B, D, E, H, G, J, and I are extracted. The extracted coordinates of the apexes are used for dividing a wiring into multiple rectangles as illustrated in FIG. 10 as the previous stage of dividing the wiring into multiple rectangular regions that are mutually not contained.

The rectangular region generating unit 114 performs processing for extracting multiple rectangular regions that are mutually not contained from the wiring pattern represented by the polygon data which the polygon data read-in unit 112 read in, in accordance with the rule 1. The rectangular region generating unit 114 performs processing for extracting multiple rectangular regions that are mutually not contained by scanning a line segment between apexes of a wiring represented by a polygon in the X-axis direction and Y-axis direction.

Specifically, for example, the rectangular region generating unit 114 extracts the region ABJI (FIG. 11B) and region CEHF (FIG. 11C) by scanning a line segment between apexes of the wiring 70 represented by the polygon ABDEHGJI illustrated in FIG. 11A, in the x-axial direction and y-axial direction.

The region width setting unit 115 sets, regarding all of the regions which the rectangular region generating unit 114 extracted, the widths of the regions in accordance with the rule 2 and rule 6. The widths of the regions are set to the widths as to the longitudinal direction of the regions. The region width setting unit 115 sets the widths of the regions to the lengths in the transversal direction of the regions.

Also, in the event that crank connection has been performed by the crank connecting unit 119, the region width setting unit 115 sets the width of a region including a line segment of a folded portion to region width used for calculating a resistance value regarding a line segment folded by crank connection in accordance with the rule 6. This is equivalent to processing for setting the width W₁ regarding the line segments NP and SV in FIGS. 14C and 14E, for example.

In the event that the region is a regular square, the region width setting unit 115 sets the length in the X-axis direction illustrated in FIG. 8 as the width of the region.

The line segment coordinate calculating unit 116 obtains the coordinates of both edges of a line segment to be drawn on the center axis in the longitudinal direction regarding all of the regions which the rectangular region generating unit 114 extracted. The line segment is drawn from one edge to the other edge of a region on the symmetric axis in the longitudinal direction of the region, and accordingly, the coordinates of both edges of the line segment are the midpoints of the short sides of the region, respectively.

The rank order determining unit 117 determines the rank order to draw a line segment as to multiple regions in accordance with the rule 3. Let us say that the rank order to draw a line segment as to multiple regions is the rank order from a wider region to a narrow region set by the region width setting unit 115.

The rank order determining unit 117 compares the widths of all of the regions of which the widths were set by the region width setting unit 115 to determine the rank order to draw a line segment in order from a wider region to a narrower region. The width of each region is the length of the short side of each region, and accordingly, the rank order determining unit 117 determines the rank order to draw a line segment based on the length of the short side of each region.

In the event that the short side of the region is overlapped with another region, the drawing margin setting unit 118 calculates a drawing margin for shortening the length of a line segment in accordance with the rule 4, and sets the coordinates of the edge points of the line segment calculated by the line segment coordinate calculating unit 116 to the coordinate values offset by the drawing margin. Let us say that the length of the drawing margin is the length of a half of the width of another region.

Note that, in the event that there is an overlap with another region even with a portion of the short side instead of the entirety of the short side, the drawing margin setting unit 118 determines that the short side of the region is overlapped with another region, and sets a drawing margin.

In the event of drawing a line segment regarding a region of which the rank order to draw a line segment is the second and thereafter, when there is a line segment already drawn on another region having a region overlapped with the region being processed now, and an overlap with the line segment already drawn occurs in the direction where the line segment is drawn in the event of drawing a line segment on the region being processed now, the crank connecting unit 119 performs crank connection in accordance with the rule 5.

The via position adjusting unit 120 performs, in the event that the center of the via is not positioned on a line segment drawn on each of the upper layer and lower layer wirings, processing for shifting the via position so that the center of the via is positioned on the line segments in accordance with the rule 7. This is to connect the line segments of the upper layer and lower layer with the via. The coordinates of the center position of both edges of the via are included in the Annotated-GDS data, and accordingly, the via position adjusting unit 120 corrects the coordinates of the center position of both edges of the via included in the Annotated-GDS data just by the shift amount of the position of the via in accordance with the rule 7.

The resistance value calculating unit 121 calculates a resistance value regarding line segments set to all of the regions. The resistance value calculating unit 121 calculates the resistance value of each line segment by sheet resistance×line segment length÷region width.

The resistance value calculating unit 121 passes the data management unit 122 the resistance value of each line segment as resistance value data.

The data management unit 122 is a data management unit for managing processing for storing the resistance value data calculated by the resistance value calculating unit 121 in the resistance value database 101.

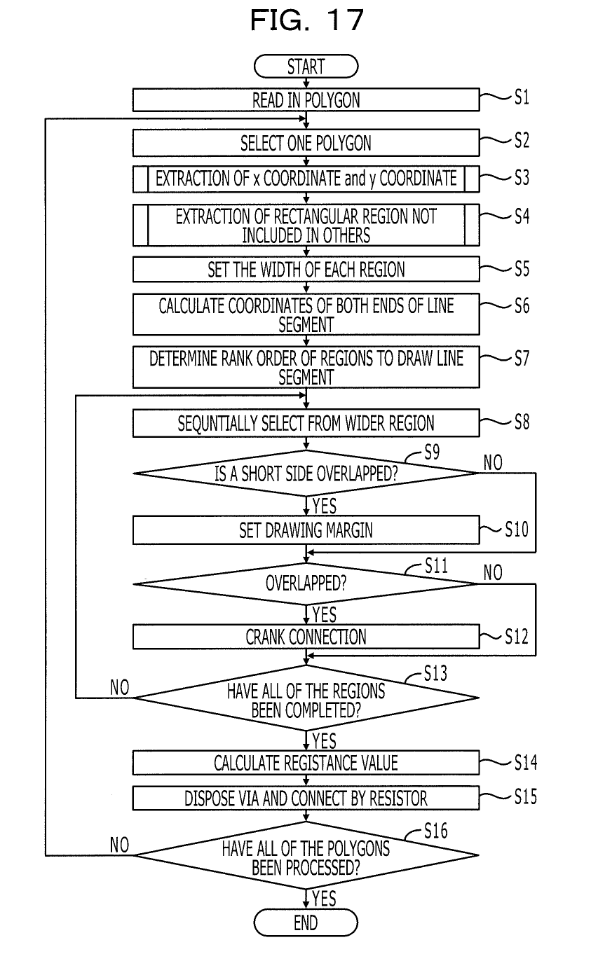

FIG. 17 is a flowchart illustrating the processing content of the resistance value calculation processing that the resistance value calculating device 100 executes, for example.

The resistance value calculating device 100 reads in all of the polygon data included in the semiconductor circuit device from the Annotated-GDS database 34 (see FIG. 6) (S1). The processing in S1 is a processing that the polygon data read-in unit 112 within the resistance value calculating device 100 executes.

Next, the resistance value calculating device 100 selects one of the polygon data read in S1 (S2). Selection of the polygon data may be selected in order from a smaller net number, for example. The processing in S2 is processing that the main control unit 111 within the resistance value calculating device 100 executes.

The resistance value calculating device 100 performs processing for extracting the coordinates of all of the apexes include in the polygon data (S3). The processing in S3 is processing that the coordinate extracting unit 113 within the resistance value calculating device 100 executes. The coordinates of the extracted apexes are used for dividing a wiring into multiple rectangles as illustrated in FIG. 10 as the previous stage for diving the wiring into multiple rectangular regions that are mutually not contained.

The resistance value calculating device 100 performs processing for extracting multiple rectangular regions that are mutually not contained from a wiring pattern that the polygon data that the polygon data read-in unit 112 read in represents (S4). The processing in S4 is processing that the rectangular region generating unit 114 within the resistance value calculating device 100 executes in accordance with the rule 1.

The resistance value calculating device 100 sets, regarding each region generated in operation S4, the width of the region (S5). The width of the region is set to the width as to the longitudinal direction of the region (the length in the transversal direction of the region). In the event that the region is a regular square, the length of the X-axis direction is set as the width of the region. The processing in S5 is processing that the region width setting unit 115 within the resistance value calculating device 100 executes in accordance with the rule 2 and rule 6.

The resistance value calculating device 100 obtains, regarding each region generated in S4, the coordinates of both edges of a line segment to be drawn on the center axis in the longitudinal direction (S6). The line segment is drawn from one edge to the other edge of the region on the symmetric axis in the longitudinal direction of the region, and accordingly, the coordinates of both edges of the line segment are the midpoints of the short sides of the region respectively. The processing in S6 is processing that the line segment coordinate calculating unit 116 within the resistance value calculating device 100 executes.

The resistance value calculating device 100 compares the widths of all of the regions set in S5 to determine the rank order to draw a line segment as to each region in order from a wider region to a narrower region (S7). The processing in S7 is processing that the rank order determining unit 117 within the resistance value calculating device 100 executes in accordance with the rule 3.

The resistance value calculating device 100 selects a region in order from a wider region in accordance with the rank order determined in S7 (S8). One line segment is selected in S8. The processing in S8 is processing that the main control unit 111 within the resistance value calculating device 100 executes.

The resistance value calculating device 100 determines whether or not the short side of the region has an overlap with another region (S9). The processing in S9 is processing that the drawing margin setting unit 118 within the resistance value calculating device 100 executes, following rule 4.

Let us say that whether or not the short side of the region has an overlap with another region is determined by determining whether or not a part of the short side has an overlap with another region instead of determining whether or not the entire short side is overlapped.

In the event that determination is made in S9 that the short side of the region has an overlap with another region (S9 YES), the resistance value calculating device 100 sets a drawing margin on the edge point of the line segment included in the short side where an overlap occurs (the midpoint of the short side of the region) (S10). The processing in S10 is processing that the drawing margin setting unit 118 within the resistance value calculating device 100 executes in accordance with the rule 4.

According to the processing in S10, the coordinates of the edge points of the line segment are set to the coordinate value offset by the drawing margin. The length of the drawing margin is the length of a half of the width of another region.

Note that, in the event that determination is made in S9 that the short side of the region has no overlap with another region (S9: NO), the resistance value calculating device 100 skips the processing in S10.

The resistance value calculating device 100 determines, regarding another region having a region overlapped with the region being processed now, whether or not an overlap occurs between the line segment of the region being processed now and a line segment already drawn on another region (S11). The processing in S11 is processing that the crank connecting unit 119 within the resistance value calculating device 100 executes.

Another region serving as a determination object in S11 is a region where a line segment has already been drawn, and accordingly is a region of which the rank order to draw a line segment is earlier than the region being processed now.

Determination regarding whether or not an overlap occurs is performed by comparing the coordinates of the line segment of the region being processed now, and the coordinates of the already drawn line segment to determine whether or not there is a section overlapped in the X-axis direction or Y-axis direction.

An overlap occurs regarding the region of which the rank order to draw a line segment is the second and thereafter, and accordingly, no overlap occurs regarding the region of which the rank order to draw a line segment is the first. Accordingly, the determination result in S11 regarding the region of which the rank order to draw a line segment is first, is NO.

In the event that determination is made in S11 that an overlap occurs (S11: YES), the resistance value calculating device 100 performs crank connection of the line segment to be drawn regarding the region being performed now as to the line segment already drawn on another region (S12). The processing in S12 is processing that the crank connecting unit 119 within the resistance value calculating device 100 executes.

The resistance value calculating device 100 does not draw the line segment as to a section where an overlap occurs, folds the line segment as illustrated in FIG. 13D and FIG. 13E to perform crank connection as to the line segment already drawn on the region of which the rank order to draw a line segment is earlier than the region being processed now.

Note that, in the event that determination is made that no overlap occurs (S11: NO), the resistance value calculating device 100 skips the processing in S12.

The resistance value calculating device 100 determines, regarding all of the regions, whether or not the processing to draw a line segment has been completed (S13). The processing in S13 is processing that the main control unit 111 within the resistance value calculating device 100 executes, and is processing for determining whether or not the processing to draw a line segment has been completed regarding all of the regions of which the rank orders have determined in S7.

In the event that determination is made that the processing to draw a line segment has been completed regarding all of the regions (S13: YES), the resistance value calculating device 100 advances the processing to S14.

On the other hand, in the event that determination is made that the processing to draw a line segment has not been completed regarding all of the regions (S13: NO), the resistance value calculating device 100 returns the processing to S8.

Upon the processing being returned, the next region to draw a line segment is selected in S8, and the processing in S9 to S13 is repeatedly executed.

The processing in S8 to S13 is repeatedly executed regarding all of the regions of which the rank orders have been determined in S7, and a line segment is drawn regarding all of the regions of which the rank orders determined in S7.

In the event that determination is made that the processing to draw a line segment has been completed regarding all of the regions (S13: YES), the resistance value calculating device 100 uses the length of the line segment drawn on each region (line segment length), and the width of the region set regarding each region (region width) to calculate a resistance value that each line segment serving as a resistance component represents (S14).

The processing in S14 is processing that the resistance value calculating unit 121 within the resistance value calculating device 100 executes, and the resistance value calculating unit 121 calculates the resistance value of each line segment by sheet resistance×line segment length÷region width.

The resistance value of each line segment calculated by the resistance value calculating unit 121 is stored in the resistance value database 101 by the data management unit 122 as resistance value data in a manner correlated with the identifier of the line segment.

The resistance value calculating device 100 compares the coordinates of both edges of a line segment drawn on each region, and the coordinates of the center position of the via according to the processing in S1 to S13, and in the event that the center position of the via is not positioned on the line segment, performs processing for adjusting the center position of the via so as to be positioned on the line segment (S15).

The processing in S15 is processing to be performed for connecting the upper layer and lower layer line segments and the via, which the via position adjusting unit 120 within the resistance value calculating device 100 executes in accordance with the rule 7.

Note that, in the event that the center position of the via is on the line segment, adjustment of the center position of the via is not performed.

The resistance value calculating device 100 determines whether or not the processing to calculate a resistance value has been completed regarding all of the polygons (S16).

The processing in S16 is processing for determining whether or not processing up to a wiring of which the net number is the largest has been completed regarding all of the polygon data read in S1, which the main control unit 111 within the resistance value calculating device 100 executes.

In the event that determination is made that the processing to calculate a resistance value has not been completed regarding all of the polygons (S16: NO), the resistance value calculating device 100 returns the processing to S2. In this case, in the subsequent S2, the polygon data representing the wiring of the next net number is selected, and the processing in S3 to S15 is executed regarding the next polygon data.

On the other hand, in the event that determination is made that the processing to calculate a resistance value has been completed regarding all of the polygons (S16: YES), the resistance value calculating device 100 ends the series of the processing.

Thus, the processing to calculate a resistance value by drawing a line segment representing a resistance component regarding all of the polygon data read in from the Annotated-GDS database 34 in S1 has been completed. Thus, the resistance values of all of the wirings included in the semiconductor circuit device such as an LSI may be obtained.

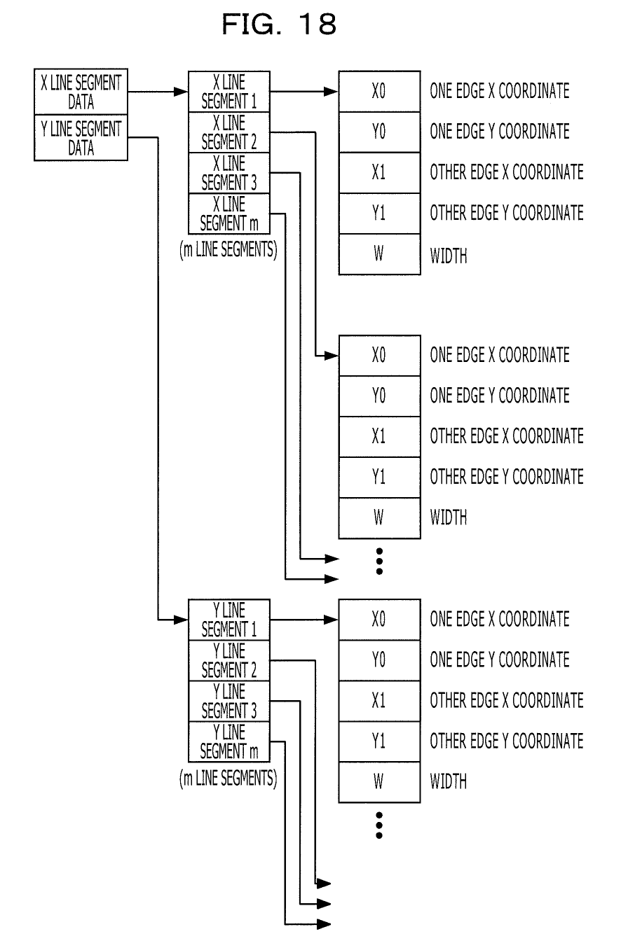

FIG. 18 is a diagram illustrating the data structure of a line segment used for resistance calculation by the resistance value calculating method according to an embodiment.

The data structure of line segments illustrated in FIG. 18 has a structure in which the line segment data in the X-axis direction (X line segment data) and the line segment data in the Y-axis direction (Y line segment data) of line segments included in the wiring that the polygon data represents are correlated.

The X line segment data includes, of the line segments included in the wiring that the polygon data represents, the coordinates of both edges of a line segment drawn in the X-axis direction in the X-Y coordinates, and region width.

The X line segment data is hierarchized as illustrated in FIG. 18, wherein X coordinate of one edge (X0), Y coordinate of one end (Y0), X coordinate of the other edge (X1), Y coordinate of the other edge (Y1) and region width (W) regarding each of m (m is an optional integer) line segments (X line segment 1, X line segment 2, X line segment 3, and X line segment m) are correlated.

The data format of a portion representing line segments (X line segment 1, X line segment 2, X line segment 3, and X line segment m) is a variable length array, and accordingly, this has a data structure that may handle however great the number of line segments is when sequentially drawing a line segment regarding each region.

The Y line segment data includes, of the line segments include in the wiring that the polygon data represents, the coordinates of both edges of a line segment drawn in the Y-axis direction in the X-Y coordinates, and region width.

The Y line segment data is hierarchized as illustrated in FIG. 18, wherein X coordinate of one edge (X0), Y coordinate of one end (Y0), X coordinate of the other edge (X1), Y coordinate of the other edge (Y1) and region width (W) regarding each of n (n is an optional integer) line segments (Y line segment 1, Y line segment 2, Y line segment 3, and Y line segment n) are correlated.

For example, with regard to the data structure of the line segments regarding the five of the line segment KN, line segment NP, line segment PV, line segment VS, and line segment SL illustrated in FIGS. 14B to 14F, the line segments in the X-axis direction are two of the line segment NP and line segment SV, and the line segments in the Y-axis direction are three of the line segment KN and line segment PV, and line segment SL, and accordingly, m is 2, and n is 3.

That is to say, the X line segment 1 illustrated in FIG. 18 is the line segment NP, the X line segment 2 is the line segment VS, the Y line segment 1 is the line segment KN, the Y line segment 2 is the line segment PV, and the Y line segment 3 is the line segment SL, respectively.

The X coordinate of one edge (X0), Y coordinate of one end (Y0), X coordinate of the other edge (X1), and Y coordinate of the other edge (Y1) regarding each of the X line segment 1, X line segment 2, Y line segment 1, and Y line segment 2, and Y line segment 3 represent the X coordinate and Y coordinate of one edge and other edge of the line segment KN, line segment NP, line segment PV, line segment VS, and line segment SL, respectively.

Also, the width W regarding each of the X line segment 1, X line segment 2, Y line segment 1, and Y line segment 3 represents the region width W₁ of the line segment KN, line segment NP, line segment VS, and line segment SL. The width W regarding the Y line segment 2 represents the region width W₂ of the line segment PV.

With the resistance value calculating method according to an embodiment, the line segment data illustrated in FIG. 18 is used to perform calculation of a resistance value.

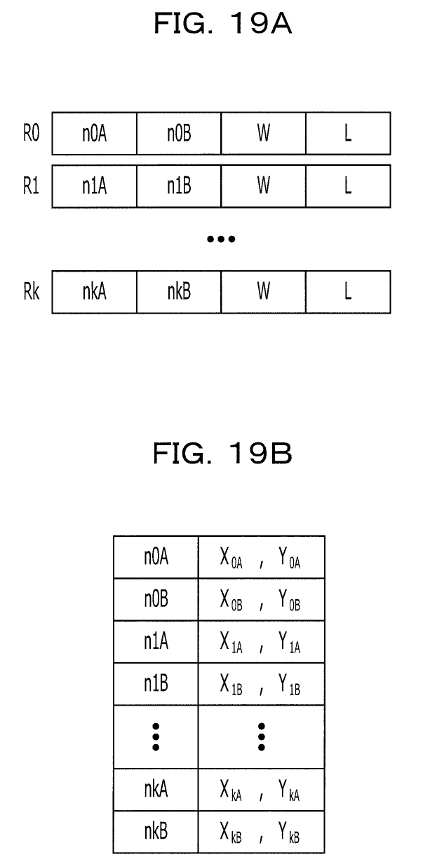

FIGS. 19A and 19B are diagrams illustrating the structure of resistance value data representing the resistance value of a line segment to be calculated by the resistance value calculating method according to an embodiment.

The resistance value data illustrated in FIG. 19A is converted into table data in a determinant format representing the resistance value of each of the X line segment 1, X line segment 2, Y line segment 1, and Y line segment 2, and Y line segment 3 illustrated in FIG. 18.

The resistance value data is created one at a time as to each line segment, and includes a resistance ID (Identification), a node n0, a node n1, region width W, and line segment length L. The node n0 (node0) represents one edge of a line segment, and the node n1 (node1) represents the other edge of the line segment. The region width W is the region width of a line segment, and the line segment length is the length of the line segment.

The values of the coordinates (X, Y) of the nodes n0 and n1 of each line segment is, as illustrated in FIG. 19B, created along with the table data in a determinant format in which table data correlated for each node represents a resistance value.

For example, with regard to the five of the line segment KN, line segment NP, line segment PV, line segment VS, and line segment SL illustrated in FIGS. 14B to 14F, five resistance value data R0 to R4 are created.

The resistance value data in the event that the X line segment 1 is the line segment NP, the X line segment 2 is the line segment VS, the Y line segment 1 is the line segment KN, the Y line segment 2 is the line segment PV, and the Y line segment 3 is the line segment SL in FIG. 18 is as follows.

The resistance value data is arrayed in the order of the line segment KN, line segment NP, line segment PV, line segment VS, and line segment SL such that R0 is the resistance value data of the Y line segment 1 (line segment KN), R1 is the resistance value data of the X line segment 1 (line segment NP), R2 is the resistance value data of the Y line segment 2 (line segment PV), R3 is the resistance value data of the X line segment 2 (line segment VS), and R4 is the resistance value data of the Y line segment 3 (line segment SL).

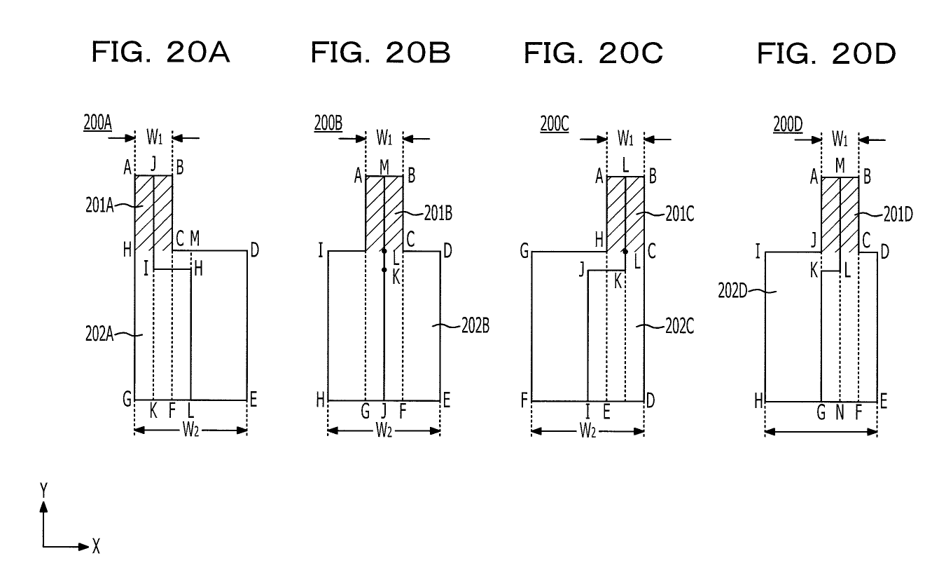

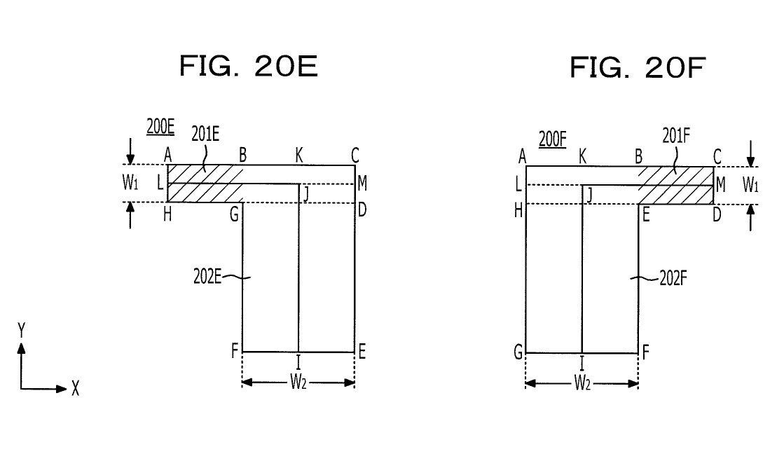

Next, description will be made regarding a technique for drawing a line segment representing a resistance component regarding a wiring having various patterns in accordance with the rules 1 to 7, with reference to FIGS. 20A to 24C.

Wirings 200A to 200F illustrated in FIGS. 20A to, 20B, 20C, 20D, 20E and 20F (20A to 20F) are wirings wherein wirings 201A to 201F (portions with hatching), and wirings 202A to 202F (portions without hatching) are connected using a different pattern, respectively.

In the event of the wiring 200A illustrated in FIG. 20A, in accordance with the rule 1, multiple rectangular regions that are mutually not contained are a region ABFG and a region HDEG.

In accordance with the rule 2, with regard to the region ABFG and region HDEG, the direction where a line segment is drawn is the Y-axis direction, and the width of the region is the X-axis direction.

The width W₂ of the region HDEG is wider than the width W₁ of the region ABFG, and accordingly, the rank order to draw a line segment comes first regarding the region HDEG, and comes later regarding the region ABFG in accordance with the rule 3.

Upon attempting to draw a line segment on a line segment LM serving as the symmetric axis in the longitudinal direction of the region HDEG, another region ABFG is overlapped with the short side HD of the region HDEG, and accordingly, the line segment LM has to have a drawing margin regarding the edge point M in accordance with the rule 4. The length of the drawing margin is a half of the width W₁ of another region ABFG (W₁/2), and accordingly, the edge point M of the line segment LM is changed to a point H in front by W₁/2.

Thus, the line segment to be drawn regarding the region HDEG has become a line segment LH.

Next, at the time of drawing a line segment regarding the region ABFG, upon attempting to draw a line segment on a line segment KJ serving as the symmetric axis in the longitudinal direction, of the line segment KJ, a line segment KI has an overlap with the already drawn line segment LH, and accordingly, crank connection will be performed in accordance with the rule 5.

Therefore, no line segment is drawn regarding the line segment KI of the line segment KJ, a line segment is drawn regarding the line segment IJ, and also the line segment IJ is folded at the edge point Ito perform crank connection as to the line segment LH.

Thus, with the wiring 200A illustrated in FIG. 20A, the line segment LH, line segment HI, and line segment IJ are drawn as resistance components. Note that the region width of the line segment LH is W₂, and the region width of the line segment HI is W₁, and the region width of the line segment IJ is W₁.

The wiring 200B illustrated in FIG. 20B is a modification of the wiring 200A illustrated in FIG. 20A.

Multiple rectangular region ABFG and region IDEH that are mutually not contained are obtained from the wiring 200B.

In accordance with the rule 2, with the region ABFG and region IDEH, the direction where a line segment is drawn is the Y-axis direction, and the width of the region is the X-axis direction.

The width W₂ of the region IDEH is wider than the width W₁ of the region ABFG, and accordingly, the rank order to draw a line segment comes first regarding the region IDEH, and comes later regarding the region ABFG in accordance with the rule 3.

Upon attempting to draw a line segment on a line segment JL serving as the symmetric axis in the longitudinal direction of the region IDEH, another region ABFG is overlapped with the short side ID of the region IDEH, and accordingly, the line segment JL has to have a drawing margin regarding the edge point L in accordance with the rule 4. The length of the drawing margin is a half of the width W₁ of another region ABFG (W₁/2), and accordingly, the edge point L of the line segment JL is changed to a point K in front by W₁/2.

Thus, the line segment to be drawn regarding the region IDEH has become a line segment JK.

Next, at the time of drawing a line segment on the region ABFG, upon attempting to draw a line segment on a line segment JM serving as the symmetric axis in the longitudinal direction, of the line segment JM, a line segment JK has an overlap with the already drawn line segment JK, and accordingly, crank connection will be performed in accordance with the rule 5.

However, at this time, with the line segment JK and line segment JM, the value in the X-axis direction is the same, and is on the same straight line, and accordingly, the length of crank is set to zero.

Therefore, no line segment is drawn regarding the line segment JK of the line segment JM, and a line segment is drawn regarding the line segment KM to connect to the already drawn line segment JK.

Thus, with the wiring 200B illustrated in FIG. 20B, the line segment JK and line segment KM are drawn as resistance components. Note that the region width of the line segment JK is W₂, and the region width of the line segment KM is W₁.

The wiring 200C illustrated in FIG. 20C is a modification of the wiring 200A illustrated in FIG. 20A.

In the case of the wiring 200C, multiple rectangular regions that are mutually not contained are a region ABDE and a region GCDF in accordance with the rule 1.

The wiring 200C has a line symmetry pattern as to the wiring 200A, and accordingly, description of line segment extraction process will be omitted.

With the wiring 200C illustrated in FIG. 20C, the line segment IJ, line segment JK and line segment KL are drawn as resistance components. Note that the region width of the line segment IJ is W₂, the region width of the line segment JK is W₁, and the region width of the line segment KL is W₁.

The wiring 200D illustrated in FIG. 20D is a modification of the wiring 200A illustrated in FIG. 20A.

In the case of the wiring 200D, multiple rectangular regions that are mutually not contained are a region ABFG and a region IDEH in accordance with the rule 1.

In accordance with the rule 2, with the region ABFG and region IDEH, the direction where a line segment is drawn is the Y-axis direction, and the width of the region is the X-axis direction.

The width W₂ of the region IDEH is wider than the width W₁ of the region ABFG, and accordingly, the rank order to draw a line segment comes first regarding the region IDEH, and comes later regarding the region ABFG in accordance with the rule 3.

Upon attempting to draw a line segment on a line segment GJ serving as the symmetric axis in the longitudinal direction of the region IDEH, another region ABFG is overlapped with the short side ID of the region IDEH, and accordingly, the line segment GJ has to have a drawing margin regarding the edge point J in accordance with the rule 4. The length of the drawing margin is a half of the width W₁ of another region ABFG (W₁/2), and accordingly, the edge point J of the line segment GJ is changed to a point K in front by W₁/2.

Thus, the line segment to be drawn regarding the region IDEH has become a line segment GK.

Next, at the time of drawing a line segment on the region ABFG, upon attempting to draw a line segment on a line segment MN serving as the symmetric axis in the longitudinal direction, of the line segment MN, a line segment LN has an overlap with the already drawn line segment GK, and accordingly, crank connection will be performed in accordance with the rule 5.

Therefore, no line segment is drawn regarding the line segment LN of the line segment MN, a line segment is drawn regarding the line segment ML, and also the line segment ML is folded at the edge point L to perform crank connection as to the line segment GK. Thus, a line segment KL is generated.

Thus, with the wiring 200D illustrated in FIG. 20D, the line segment GK, line segment KL, and line segment LM are drawn as resistance components. Note that the region width of the line segment GK is W₂, and the region width of the line segment KL is W₁, and the region width of the line segment LM is W₁.

Multiple rectangular region ACDH and region BCEF that are mutually not contained are obtained from the wiring 200E illustrated in FIG. 20E.

In accordance with the rule 2, with the region ACDH, the direction where a line segment is drawn is the X-axis direction, and the width of the region is the Y-axis direction. Also, with the region BCEF, the direction where a line segment is drawn is the Y-axis direction, and the width of the region is the X-axis direction.

The width W₂ of the region BCEF is wider than the width W₁ of the region ACDH, and accordingly, the rank order to draw a line segment comes first regarding the region BCEF, and comes later regarding the region ACDH in accordance with the rule 3.

Upon attempting to draw a line segment on a line segment IK serving as the symmetric axis in the longitudinal direction of the region BCEF, another region ACDH is overlapped with the short side BC of the region BCEF, and accordingly, the line segment IK has to have a drawing margin regarding the edge point K in accordance with the rule 4. The length of the drawing margin is a half of the width W₁ of another region ACDH (W₁/2), and accordingly, the edge point K of the line segment IK is changed to a point J in front by W₁/2.

Thus, the line segment to be drawn regarding the region BCEF has become a line segment IJ.

Next, at the time of drawing a line segment on the region ACDH, upon attempting to draw a line segment on a line segment LM serving as the symmetric axis in the longitudinal direction, another region BCEF is overlapped with the short side DC of the region ACDH, and accordingly, the line segment LM has to have a drawing margin regarding the edge point M in accordance with the rule 4. The length of the drawing margin is a half of the width W₂ of another region BCEF (W₂/2), and accordingly, the edge point M of the line segment LM is changed to a point J in front by W₂/2.

Thus, the line segment to be drawn regarding the region BCEF has become a line segment IJ.

Thus, with the wiring 200E illustrated in FIG. 20E, the line segment IJ, and line segment JL are drawn as resistance components. Note that the region width of the line segment IJ is W₂, and the region width of the line segment JL is W₁.

Multiple rectangular region ACDH and region ABFG that are mutually not contained are obtained from the wiring 200F illustrated in FIG. 20F.

The wiring 200F has a line symmetry pattern as to the wiring 200E illustrated in FIG. 20E, and accordingly, description of line segment extraction process in FIG. 20F will be omitted.

With the wiring 200F illustrated in FIG. 20F, the line segment IJ and line segment JM are drawn as resistance components. Note that the region width of the line segment IJ is W₂, and the region width of the line segment JM is W₁.

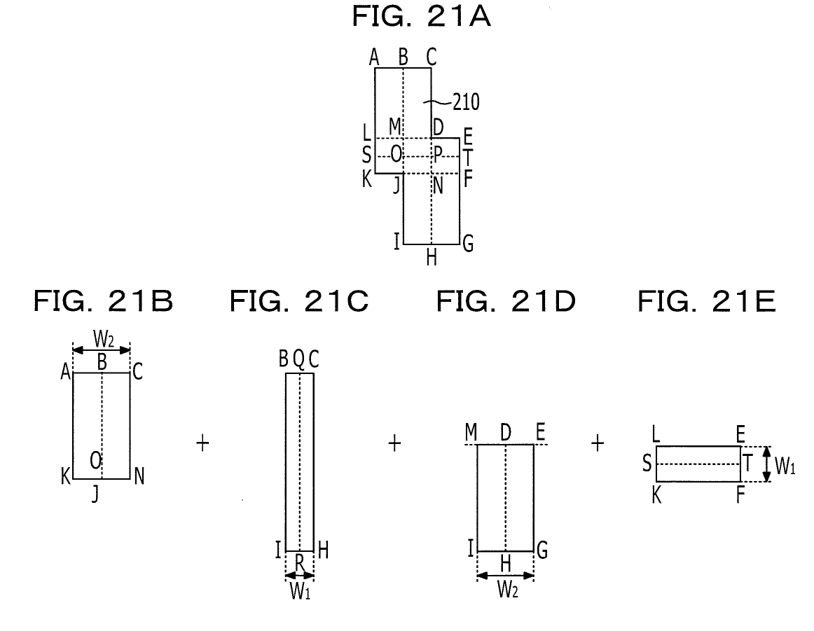

Four multiple rectangular region ACNK (FIG. 21B), region BCHI (FIG. 21C), region MEGI (FIG. 21D), and region LEFK (FIG. 21E) that are mutually not contained are obtained from the wiring 210 illustrated in FIG. 21A.

In accordance with the rule 2, with the region ACNK, region BCHI, and region MEGI, the direction where a line segment is drawn is the Y-axis direction, and the width of the region is the X-axis direction. Also, with the region LEFK, the direction where a line segment is drawn is the X-axis direction, and the width of the region is the Y-axis direction.

The width W₂ of the region ACNK and region MEGI is wider than the width W₁ of the region BCHI and region LEFK, and accordingly, the rank order to draw a line segment comes first regarding the region ACNK and region MEGI, and comes later regarding the region BCHI and region LEFK in accordance with the rule 3. Here, W₂=2×W₁ holds.

Upon attempting to draw a line segment on a line segment JB serving as the symmetric axis in the longitudinal direction of the region ACNK, other region BCHI and region LEFK are overlapped with the short side KN of the region ACNK, and accordingly, the line segment JB has to have a drawing margin regarding the edge point J in accordance with the rule 4. The length of the drawing margin is a half of the width W₁ of other region BCHI and region LEFK (W₁/2), and accordingly, the edge point J of the line segment JB is changed to a point O in front by W₁/2.

Thus, the line segment to be drawn regarding the region ACNK has become a line segment OB.

Similarly, the line segment to be drawn regarding the region MEGI becomes a line segment HP.

Next, at the time of drawing a line segment on the region BCHI, upon attempting to draw a line segment on a line segment RQ serving as the symmetric axis in the longitudinal direction, the RQ is wholly overlapped from one edge R to the other edge Q with the already drawn line segment OB and line segment HP. Accordingly, no line segment to be drawn is generated regarding the region BCHI.

Also, at the time of drawing a line segment on the region LEFK, upon attempting to draw a line segment on a line segment ST serving as the symmetric axis in the longitudinal direction, other region ACNK and region MEGI are overlapped with the short side KL and short side FE of the region LEFK, and accordingly, the line segment ST has to have a drawing margin regarding both of the edge point S and edge point T in accordance with the rule 4. The lengths of the drawing margins are a half of the width W₂ of other region ACNK and region MEGI (W₂/2), and accordingly, the edge point S and edge point T of the line segment ST are changed to a point O and a point P in front by W₂/2, respectively.

Thus, with the wiring 210 illustrated in FIG. 21A, the line segment HP, line segment PO, and line segment OB are drawn as resistance components. Note that the region width of the line segment HP is W₂, the region width of the line segment PO is W₁, and the region width of the line segment OB is W₂.

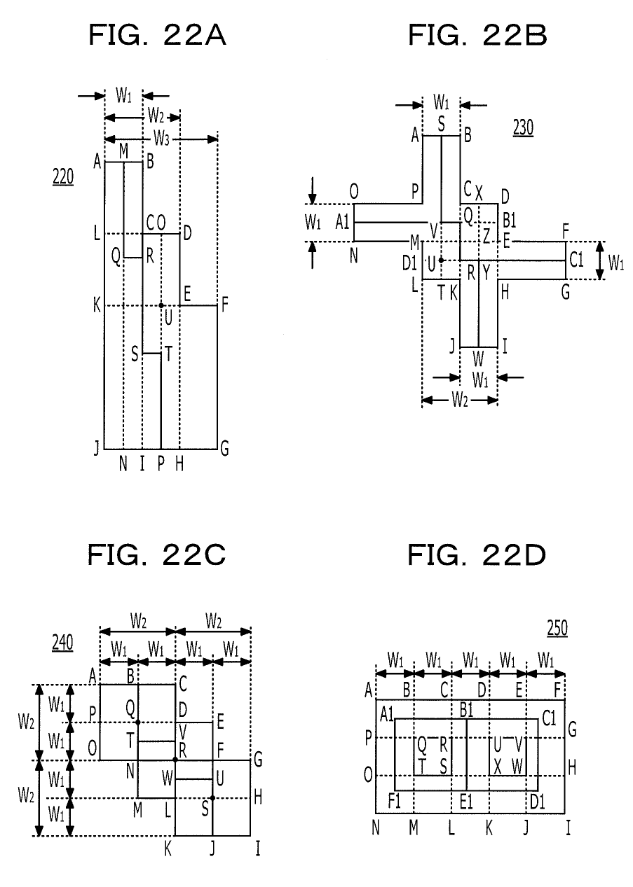

In the case of the wiring 220 illustrated in FIG. 22A, multiple rectangular regions that are mutually not contained are a region ABIJ, a region LDHJ, and a region KFGJ in accordance with the rule 1.

In accordance with the rule 2, with the region ABIJ, region LDHJ, and region KFGJ, the direction where a line segment is drawn is the Y-axis direction, and the width of the region is the X-axis direction.

The widths of the region KFGJ, region LDHJ, and region ABIJ are W₃, W₂, and W₁ respectively, and W₃>W₂>W₁ holds, and accordingly, the rank order to draw a line segment is the order of the region KFGJ, region LDHJ, and region ABIJ in accordance with the rule 3.

Upon attempting to draw a line segment on a line segment PU serving as the symmetric axis in the longitudinal direction of the region KFGJ, another region LDHJ is overlapped with the short side KF of the region KFGJ, and accordingly, the line segment PU has to have a drawing margin regarding the edge point U in accordance with the rule 4. The length of the drawing margin is a half of the width W₂ of another region LDHJ (W₂/2), and accordingly, the edge point U of the line segment PU is changed to a point T in front by W₂/2.

Thus, the line segment to be drawn regarding the region KFGJ has become a line segment PT.

Next, at the time of drawing a line segment on the region LDHJ, upon attempting to draw a line segment on a line segment IC serving as the symmetric axis in the longitudinal direction, of the line segment IC, a line segment IS has an overlap with the already drawn line segment PT, and accordingly, crank connection will be performed in accordance with the rule 5.

Also, at the time of drawing a line segment on the region LDHJ, the region ABIJ is overlapped with the short side LD of the region LDHJ, and accordingly, the line segment IC has to have a drawing margin regarding the edge point C. The length of the drawing margin is a half of the width W₁ of the region ABIJ (W₁/2) which is the other part of overlapping, and accordingly, the edge point C is offset to the point R.

As described above, upon attempting to draw the line segment IC regarding the region LDHJ, no line segment is drawn in the section IS on the edge point I side, and accordingly, a line segment ST is generated by crank connection, the edge point C side is offset to the point R, and accordingly, the line segment TS and line segment SR are drawn regarding the region LDHJ.

Next, upon attempting to draw a line segment on a line segment NM serving as the symmetric axis in the longitudinal direction of the region ABIJ, of the line segment NM, a line segment NQ has an overlap with the already drawn line segment PT and line segment SR, and accordingly, crank connection will be performed in accordance with the rule 5.

Therefore, no line segment is drawn in the section NQ regarding the line segment NM, and crank connection for connecting to the line segment SR at the point Q is performed.

Thus, with the wiring 220 illustrated in FIG. 22A, the line segment PT, line segment TS, line segment SR, line segment RQ, and line segment QM are drawn as resistance components. Note that the region width of the line segment PT is W₃, the region width of the line segment TS and line segment SR is W₂, and the region width of the line segment RQ and line segment QM is W₁.

In the case of the wiring 230 illustrated in FIG. 22B, multiple rectangular regions that are mutually not contained are a region ABKL, a region PDHL, a region CDIJ, a region MFGL, and a region ODEN in accordance with the rule 1. Note that the region PDHL is a regular square.

In accordance with the rule 2, with the region ABKL, region PDHL, and region CDIJ, the direction where a line segment is drawn is the Y-axis direction, and the width of the region is the X-axis direction. Note that the region PDHL is a regular square, and with an embodiment, a line segment is to be drawn in the Y-axis direction. Also, with the region MFGL and region ODEN, the direction where a line segment is drawn is the X-axis direction, and the width of the region is the Y-axis direction.

The widths of the region ABKL, region CDIJ, region MFGL, and region ODEN are each W₁, and the width of the region PDHL is W₂ (=2×W₁). Accordingly, the rank order to draw a line segment comes first regarding the region PDHL, and comes later regarding the region ABKL, region CDIJ, region MFGL, and region ODEN in accordance with the rule 3.

First, upon attempting to draw a line segment CK on the symmetric axis in the longitudinal direction (Y-axis direction) regarding the region PDHL, the region ABKL and region CDIJ are overlapped with the short side PD and short side LH respectively, and accordingly, the line segment CK has to have a drawing margin regarding each of the edge point C and edge point K in accordance with the rule 4. The lengths of the drawing margins are a half of the width W₁ of the other region ABKL and region CDIJ (W₁/2), and accordingly, the edge point C and edge point K of the line segment CK are changed to a point Q and a point R in front by W₁/2.

Thus, the line segment to be drawn regarding the region PDHL has become a line segment RQ.

Next, at the time of drawing a line segment regarding the region ABKL, upon attempting to draw a line segment on a line segment TS serving as the symmetric axis in the longitudinal direction, of the line segment TS, a line segment UV has an overlap with the already drawn line segment RQ, and accordingly, crank connection will be performed in accordance with the rule 5.

Also, at the time of drawing a line segment regarding the region CDIJ, upon attempting to draw a line segment on a line segment WX serving as the symmetric axis in the longitudinal direction, of the line segment WX, a line segment YZ has an overlap with the already drawn line segment RQ, and accordingly, crank connection will be performed in accordance with the rule 5.

Therefore, with regard to the region ABKL, the line segment VS is crank-connected to the line segment RQ at the point V, and accordingly, a line segment VQ is generated. Also, with regard to the region CDIJ, the line segment RQ is crank-connected to the line segment WY at the point Y, and accordingly, a line segment YR is generated.

Also, with regard to the region ODEN and region MFGL, upon attempting to draw a line segment as to each of a line segment A1B1 and a line segment D1C1, the short side DE and short side ML are overlapped with the region PDHL, and accordingly, a drawing margin has to be provided in accordance with the rule 4. The length of the drawing margin is a half of the width W₂ of the region PDHL (W₂/2=W₁) regarding both of the line segment A1B1 and line segment D1C1.

Accordingly, with regard to the region ODEN and region MFGL, a line segment is drawn as to a line segment A1Q and a line segment C1R, respectively, but the section VQ and section RY are overlapped with the already drawn line segment, and accordingly, the line segment A1Q and line segment C1R are reduced to a line segment A1V and line segment C1Y. Note that, in this case, with regard to the overlap regarding the section VQ and section RY of the line segment A1Q and line segment C1R, the value in the Y-axis direction is the same, and positioned on the same straight line, and accordingly, the length of crank is set to zero.

Thus, with the wiring 230 illustrated in FIG. 22B, the line segment WY, line segment C1Y, line segment YR, line segment RQ, line segment QV, line segment VS, and line segment VA1 are drawn. Note that the region width of the line segment RQ is W₂, the region width of the line segment WY, line segment C1Y, line segment YR, line segment QV, line segment VS, and line segment VA1 other than the line segment RQ is W₁.

With the wiring 240 illustrated in FIG. 22C, multiple rectangular regions that are mutually not contained are a region ACRO, a region QESM, a region RGIK, a region BCLM, a region DEJK, a region PEFO, and a region NGHM in accordance with the rule 1. Note that the region ACRO, region QESM, and region RGIK are regular squares.

In accordance with the rule 2, with the region ACRO, region QESM, region RGIK, region BCLM, and region DEJK, the direction where a line segment is drawn is the Y-axis direction, and the width of the region is the X-axis direction. Also, with the region PEFO and region NGHM, the direction where a line segment is drawn is the X-axis direction, and the width of the region is the Y-axis direction.

The widths of the region ACRO, region QESM, and region RGIK are each W₂(=2×W₁), and the widths of the region BCLM, region DEJK, region PEFO, and region NGHM are each W₁. Accordingly, the rank order to draw a line segment comes first regarding the region ACRO, region QESM, and region RGIK, and comes later regarding the region BCLM, region DEJK, region PEFO, and region NGHM in accordance with the rule 3.

First, upon attempting to draw a line segment NB on the symmetric axis in the longitudinal direction (Y-axis direction) regarding the region ACRO, the region PEFO is overlapped with the short side OR, and accordingly, the line segment NB has to have a drawing margin regarding the edge point N in accordance with the rule 4. The length of the drawing margin is a half of the width W₁ of another region PEFO (W₁/2), and accordingly, the edge point N of the line segment NB is changed to a point T in front by W₁/2.

Thus, the line segment to be drawn regarding the region ACRO has become a line segment TB.

Next, upon attempting to draw a line segment JF on the symmetric axis in the longitudinal direction (Y-axis direction) regarding the region RGIK, the region NGHM is overlapped with the short side RG, and accordingly, the line segment JF has to have a drawing margin regarding the edge point F in accordance with the rule 4. The length of the drawing margin is a half of the width W₁ of another region NGHM (W₁/2), and accordingly, the edge point F of the line segment JF is changed to a point U in front by W₁/2.

Thus, the line segment to be drawn regarding the region RGIK has become a line segment JU.

Next, at the time of drawing a line segment regarding the region QESM, upon attempting to draw a line segment on a line segment LD serving as the symmetric axis in the longitudinal direction, the region PEFO is overlapped with the short side QE, and accordingly, the line segment LD has to have a drawing margin regarding the edge point D in accordance with the rule 4. The length of the drawing margin is a half of the width W₁ of another region PEFO (W₁/2), and accordingly, the edge point D of the line segment LD is changed to a point V in front by W₁/2.

Also, similarly, with regard to the region QESM, the region NGHM is overlapped with the short side SM, and accordingly, the line segment LD has to have a drawing margin regarding the edge point L in accordance with the rule 4. The length of the drawing margin is a half of the width W₁ of another region NGHM (W₁/2), and accordingly, the edge point L of the line segment LD is changed to a point W in front by W₁/2.

Thus, the line segment to be drawn regarding the region QESM has become a line segment VW.

Also, with regard to the region BCLM and region DEJK, processing for drawing a line segment is completely covered by the region ACRO, region QESM, and region RGIK, and accordingly, the processing for drawing a line segment is not performed.

Next, a line segment will be drawn regarding the region PEFO, and region NGHM.

With regard to the region PEFO, the region ACRO and region QESM are overlapped with the short side PO and short side EF respectively, and accordingly, a drawing margin of a half of the widths (both W₂) of the region ACRO and region QESM (W₂/2) has to be provided.

Accordingly, the line segment to be drawn regarding the region PEFO becomes TV.

Similarly, with regard to the region NGHM, the region RGIK and region QESM are overlapped with the short side GH and short side NM respectively, and accordingly, a drawing margin of a half of the widths (both W₂) of the region RGIK and region QESM (W₂/2) has to be provided.

Accordingly, the line segment to be drawn regarding the region NGHM becomes WU.

Thus, with the wiring 240 illustrated in FIG. 22C, the line segment JU, line segment UW, line segment WV, line segment VT, and line segment TB are drawn. Note that the region widths of the line segment JU, line segment UW, line segment WV, and line segment TB are W₂, and the region widths of the line segment UW and line segment VT are W₁.

With the wiring 250 illustrated in FIG. 22D, multiple rectangular regions that are mutually not contained are a region ABMN, a region CDKL, a region EFIJ, a region AFGP, and a region OHIN in accordance with the rule 1.

In accordance with the rule 2, with the region ABMN, region CDKL, and region EFIJ, the direction where a line segment is drawn is the Y-axis direction, and the width of the region is the X-axis direction. Also, with the region AFGP and region OHIN, the direction where a line segment is drawn is the X-axis direction, and the width of the region is the Y-axis direction.

The widths of the region ABMN, region CDKL, region EFIJ, region AFGP, and region OHIN are all W₁, and accordingly, the rank orders to draw a line segment in accordance with the rule 3 are all the same.

The region ABMN, region CDKL, region EFIJ, region AFGP, and region OHIN are each overlapped with another region at the short side thereof, and accordingly have to have a drawing margin.

The lengths of the drawing margins are all W₁/2.

Accordingly, with the wiring 250, a line segment A1F1, a line segment B1E1, a line segment C1D1, a line segment A1C1, and a line segment F1D1 are drawn. Note that the region widths of the line segment A1F1, line segment B1E1, line segment C1D1, line segment A1C1, and line segment F1D1 are all W₁.

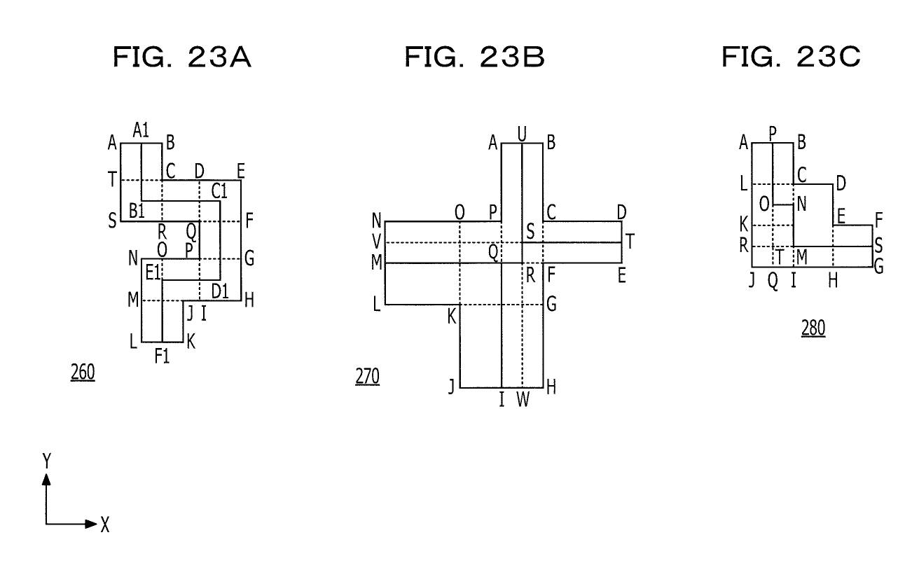

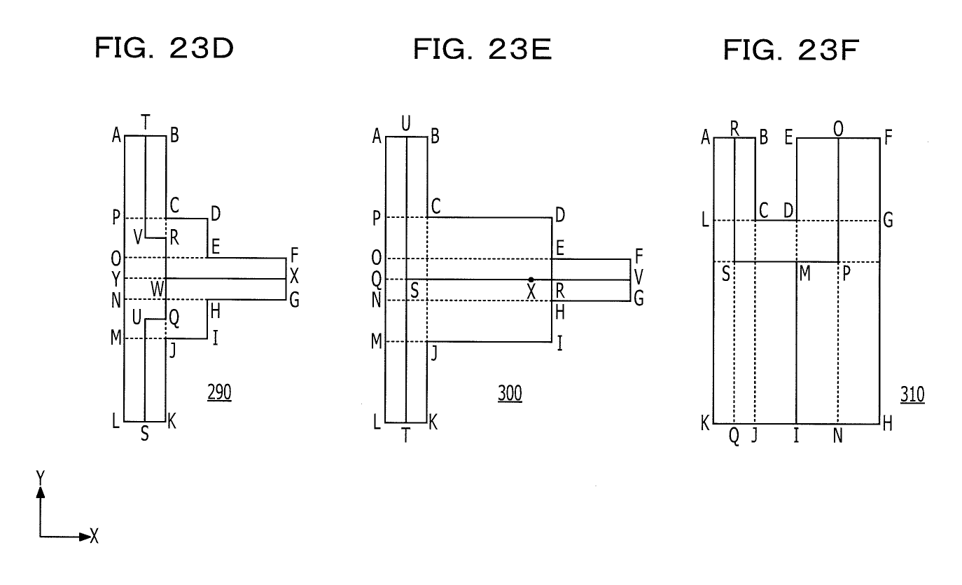

With the wiring 260 illustrated in FIG. 23A, multiple rectangular regions that are mutually not contained are a region ABRS, a region TEFS, a region DEHI, a region NGHM, and a region NOKL in accordance with the rule 1.

In accordance with the rule 2, with the region ABRS, region DEHI, and region NOKL, the direction where a line segment is drawn is the Y-axis direction, and the width of the region is the X-axis direction. Also, with the region TEFS and region NGHM, the direction where a line segment is drawn is the X-axis direction, and the width of the region is the Y-axis direction.

Let us say that the widths of the region ABRS, region TEFS, region DEHI, region NGHM, and region NOKL are all W₁. Accordingly, the rank orders to draw a line segment in accordance with the rule 3 are all the same.

The region ABRS, region TEFS, region DEHI, region NGHM, and region NOKL are each overlapped with another region at the short side thereof, and accordingly have to have a drawing margin.

The lengths of the drawing margins are all W₁/2.

Accordingly, with the wiring 260, a line segment A1B1, a line segment B1C1, a line segment C1D1, a line segment D1E1, and a line segment E1F1 are drawn. Note that the region widths of the line segment A1B1, line segment B1C1, line segment C1D1, line segment D1E1, and line segment E1F1 are all W₁.

With the wiring 270 illustrated in FIG. 23B, multiple rectangular regions that are mutually not contained are a region ABHI, a region OCHJ, a region NDEM, and a region NCGL in accordance with the rule 1.

In accordance with the rule 2, with the region ABHI and region OCHJ, the direction where a line segment is drawn is the Y-axis direction, and the width of the region is the X-axis direction. Also, with the region NDEM and region NCGL, the direction where a line segment is drawn is the X-axis direction, and the width of the region is the Y-axis direction.

The widths of the region ABHI and region NDEM are each W₁, and the widths of the region OCHJ and region NCGL are W₂(=2×W₁). Accordingly, the rank order to draw a line segment comes first regarding the region OCHJ and region NCGL, and comes later regarding the region ABHI and region NDEM in accordance with the rule 3.

First, upon attempting to draw a line segment IP on the symmetric axis in the longitudinal direction (Y-axis direction) regarding the region OCHJ, the region NCGL is overlapped with the short side OP, and accordingly, the line segment IP has to have a drawing margin regarding the edge point P in accordance with the rule 4. The length of the drawing margin is a half of the width W₂ of another region NCGL (W₂/2), and accordingly, the edge point P of the line segment IP is changed to a point Q in front by W₂/2.

Thus, the line segment to be drawn regarding the region OCHJ has become a line segment 10.

Next, at the time of drawing a line segment regarding the region NCGL, upon attempting to draw a line segment on the line segment MF serving as the symmetric axis in the longitudinal direction, the region OCHJ is overlapped with the short side CG, and accordingly, the line segment MF has to have a drawing margin regarding the edge point F in accordance with the rule 4. The length of the drawing margin is a half of the width W₂ of another region OCHJ (W₂/2), and accordingly, the edge point F of the line segment MF is changed to a point Q in front by W₂/2.

Thus, the line segment to be drawn regarding the region NCGL has become a line segment MQ.

Next, at the time of drawing a line segment regarding the region ABHI, upon attempting to draw a line segment on a line segment WU serving as the symmetric axis in the longitudinal direction, of the line segment WU, a line segment RW has an overlap with the already drawn line segment 10, and accordingly, crank connection will be performed regarding the line segment WU in accordance with the rule 5.

The remaining line segment RU obtained by removing the line segment RW from the line segment WU is crank-connected to the line segment MQ and line segment 10, thereby generating a line segment RQ.

Also, at the time of drawing a line segment regarding the region NDEM, upon attempting to draw a line segment on a line segment VT serving as the symmetric axis in the longitudinal direction, of the line segment VT, a line segment VS has an overlap with the already drawn line segment MR, and accordingly, crank connection will be performed in accordance with the rule 5.

However, the line segment SR has already been drawn at this time, and accordingly, the line segment TS is crank-connected to another line segment, and accordingly, the line segment TS alone is drawn regarding the line segment VT.

Thus, with the wiring 270 illustrated in FIG. 23B, the line segment 10, line segment MQ, line segment QR, line segment RU, and line segment ST are drawn. Note that the region widths of the line segment IQ and line segment MQ are W₂, and the region widths of the line segment QR, line segment RU, and line segment ST are W₁.

With the wiring 280 illustrated in FIG. 23C, multiple rectangular regions that are mutually not contained are a region ABIJ, a region LDHJ, and a region KFGJ in accordance with the rule 1.

In accordance with the rule 2, with the region ABIJ and region LDHJ, the direction where a line segment is drawn is the Y-axis direction, and the width of the region is the X-axis direction. Also, with the region KFGJ, the direction where a line segment is drawn is the X-axis direction, and the width of the region is the Y-axis direction.

The widths of the region ABIJ and region KFGJ are each W₁, and the width of the region LDHJ is W₂ (=2×W₁). Accordingly, the rank order to draw a line segment comes first regarding the region LDHJ, and comes later regarding the region ABIJ and region KFGJ in accordance with the rule 3.

First, upon attempting to draw a line segment IC on the symmetric axis in the longitudinal direction (Y-axis direction) regarding the region LDHJ, the region ABIJ and region KFGJ are overlapped with the short side LD and short side JH respectively, and accordingly, the line segment IC has to have a drawing margin regarding the edge point I and edge point C in accordance with the rule 4. The lengths of the drawing margins are a half of the width W₁ of other region ABIJ and region KFGJ (W₁/2), and accordingly, the edge point I and edge point C of the line segment IC are changed to a point M and a point N in front by W₁/2, respectively.

Thus, the line segment to be drawn regarding the region LDHJ has become a line segment MN.

Next, at the time of drawing a line segment regarding the region ABIJ, upon attempting to draw a line segment on a line segment QP serving as the symmetric axis in the longitudinal direction, of the line segment QP, a line segment OT has an overlap with the already drawn line segment MN, and accordingly, crank connection will be performed in accordance with the rule 5.

Also, at the time of drawing a line segment regarding the region KFGJ, upon attempting to draw a line segment on the line segment RS serving as the symmetric axis in the longitudinal direction, the region LDHJ is overlapped with the short side KJ, and accordingly, the line segment RS has to have a drawing margin regarding the edge point R in accordance with the rule 4. The length of the drawing margin is a half of the width W₂ of another region LDHJ (W₂/2), and accordingly, the edge point R of the line segment RS is changed to a point M in front by W₂/2.

Thus, the line segment to be drawn regarding the region ABIJ has become a line segment OP, and the line segment to be drawn regarding the region KFGJ has become a line segment MS.

Thus, with the wiring 280 illustrated in FIG. 23C, the line segment SM, line segment MN, line segment NO, and line segment OP are drawn. Note that the region width of the line segment MN is W₂, and the region widths of the line segment SM, line segment NO, and line segment OP are W₁.

With the wiring 290 illustrated in FIG. 23D, multiple rectangular regions that are mutually not contained are a region ABKL, a region PDIM, and a region OFGN in accordance with the rule 1.

In accordance with the rule 2, with the region ABKL and region PDIM, the direction where a line segment is drawn is the Y-axis direction, and the width of the region is the X-axis direction. Also, with the region OFGN, the direction where a line segment is drawn is the X-axis direction, and the width of the region is the Y-axis direction.

The widths of the region ABKL and region OFGN are each W₁, and the width of the region PDIM is W₂ (=2×W₁). Accordingly, the rank order to draw a line segment comes first regarding the region PDIM, and comes later regarding the region ABKL and region OFGN in accordance with the rule 3.

First, upon attempting to draw a line segment JC on the symmetric axis in the longitudinal direction (Y-axis direction) regarding the region PDIM, the region ABKL is overlapped with the short side PD and short side MI, and accordingly, the line segment JC has to have a drawing margin regarding the edge point J and edge point C in accordance with the rule 4. The lengths of the drawing margins are a half of the width W₁ of another region ABKL (W₁/2), and accordingly, the edge point J and edge point C of the line segment JC are changed to a point Q and a point R in front by W₁/2, respectively.

Thus, the line segment to be drawn regarding the region PDIM has become a line segment QR.

Next, at the time of drawing a line segment regarding the region ABKL, upon attempting to draw a line segment on a line segment ST serving as the symmetric axis in the longitudinal direction, of the line segment ST, a line segment UV has an overlap with the already drawn line segment QR, and accordingly, crank connection will be performed in accordance with the rule 5.

Accordingly, the line segment to be drawn regarding the region ABKL is the line segment SU and line segment VT, and the line segment SU is crank-connected to the line segment QR at the point U. Thus, a line segment UQ is generated.

Also, the line segment VT is crank-connected to the line segment QR at the point V, and thus, a line segment VR is generated.

Thus, the line segments to be drawn regarding the region ABKL are the line segment SU, line segment UQ, line segment RV, and line segment VT.

Next, upon attempting to draw a line segment XY on the symmetric axis in the longitudinal direction (Y-axis direction) regarding the region OFGN, the region PDIM is overlapped with the short side ON, and accordingly, the line segment XY has to have a drawing margin regarding the edge point Y in accordance with the rule 4. The length of the drawing margin is a half of the width W₂ of another region PDIM (W₂/2), and accordingly, the edge point Y of the line segment XY is changed to a point W in front by W₂/2 (=W₁).

Thus, the line segment to be drawn regarding the region OFGN has become a line segment WX.

Thus, with the wiring 290 illustrated in FIG. 23D, the line segment SU, line segment UQ, line segment QR, line segment WX, line segment RV, and line segment VT are drawn. Note that the region width of the line segment QR is W₂, and the region widths of the line segment SU, line segment UQ, line segment WX, line segment RV, and line segment VT are W₁.

With the wiring 300 illustrated in FIG. 23E, multiple rectangular regions that are mutually not contained are a region ABKL, a region PDIM, and a region OFGN in accordance with the rule 1.

In accordance with the rule 2, with the region ABKL, the direction where a line segment is drawn is the Y-axis direction, and the width of the region is the X-axis direction. Also, with the region PDIM and region OFGN, the direction where a line segment is drawn is the X-axis direction, and the width of the region is the Y-axis direction.

The widths of the region ABKL and region OFGN are each W₁, and the width of the region PDIM is W₃ (=3×W₁). Accordingly, the rank order to draw a line segment comes first regarding the region PDIM, and comes later regarding the region ABKL and region OFGN in accordance with the rule 3.

First, upon attempting to draw a line segment QR on the symmetric axis in the longitudinal direction (X-axis direction) regarding the region PDIM, the region ABKL and region OFGN are overlapped with the short side PM and short side DI, and accordingly, the line segment QR has to have a drawing margin regarding the edge point Q and edge point R in accordance with the rule 4. The lengths of the drawing margins are a half of the width W₁ of other region ABKL and region OFGN (W₁/2), and accordingly, the edge point Q and edge point R of the line segment QR are changed to a point S and a point X in front by W₁/2, respectively.

Thus, the line segment to be drawn regarding the region PDIM has become a line segment SX.

Next, at the time of drawing a line segment regarding the region ABKL, upon attempting to draw a line segment on a line segment TU serving as the symmetric axis in the longitudinal direction, the region ABKL is overlapped with the region PDIM and region OFGN, but no overlap with a line segment occurs.

Accordingly, the rule 5 is not applied to this, and the line segment TU is drawn regarding the region ABKL.

Next, upon attempting to draw a line segment QV on the symmetric axis in the longitudinal direction (X-axis direction) regarding the region OFGN, the region ABKL is overlapped with the short side ON, and accordingly, the line segment QV has to have a drawing margin regarding the edge point Q in accordance with the rule 4. The length of the drawing margin is a half of the width W₁ of another region ABKL (W₁/2), and accordingly, the edge point Q of the line segment QV is changed to a point S in front by W₁/2 (=W₁).

Also, with the region OFGN, of the line segment SV, the line segment SX has an overlap with the line segment SX already drawn regarding the region PDIM, and accordingly, crank connection will be performed in accordance with the rule 5.

However, at this time, the line segment SV and line segment SX have the same value in the Y-axis direction and positioned on the same straight line, and accordingly, the length of crank is set to zero.

Accordingly, with the region OFGN, the line segment XV obtained by removing the line segment SX from the line segment SV will be drawn.

Thus, with the wiring 300 illustrated in FIG. 23E, the line segment SX, line segment XV, and line segment TU are drawn. Note that the region width of the line segment SX is W₃, and the region widths of the line segment XV and line segment TU are W₁.

With the wiring 310 illustrated in FIG. 23F, multiple rectangular regions that are mutually not contained are a region ABJK, a region EFHI, and a region LGHK, following rule 1.

In accordance with the rule 2, with the region ABJK, region EFHI, and region LGHK, the direction where a line segment is drawn is the Y-axis direction, and the region width is the X-axis direction.

The width of the region ABJK is W₁, and the width of the region EFHI is W₂ (=2×W₁), and the width of the region LGHK is W₄ (=4×W₁). Accordingly, the rank order to draw a line segment is the rank order of the region LGHK, region EFHI, and region ABJK, following rule 3.

First, upon attempting to draw a line segment ID on the symmetric axis in the longitudinal direction (Y-axis direction) regarding the region LGHK, the region ABJK and region EFHI are overlapped with the short side LG, and accordingly, the line segment ID has to have a drawing margin regarding the edge point D in accordance with the rule 4.

Here, the region ABJK and region EFHI differ in width, and accordingly, the length of the drawing margin is a half of the width W₂ of the region EFHI which is wider of other regions (W₂/2=W₁). Accordingly, the edge point D of the line segment ID is changed to a point M in front by W₁.

Thus, the line segment to be drawn regarding the region LGHK has become a line segment IM.

Next, at the time of drawing a line segment regarding the region EFHI, upon attempting to draw a line segment on a line segment NO serving as the symmetric axis in the longitudinal direction, the region EFHI is overlapped with the region LGHK, and of the line segment NO, a line segment NP has an overlap with the line segment IM of the region LGHK.

Accordingly, the point P of the remaining line segment PO obtained by removing the line segment NP from the line segment NO is crank-connected to the line segment IM, and a line segment PM is generated.

Also, upon attempting to draw a line segment QR regarding the region ABJK, this line segment has an overlap with the line segment IM of the region LGHK, and accordingly, the point S of the remaining line segment SR obtained by removing the line segment QS from the line segment QR is crank-connected to the line segment IM, and a line segment SM is generated.

Thus, with the wiring 310 illustrated in FIG. 23F, the line segment IM, line segment MP, line segment PO, line segment MS, and line segment SR are drawn. Note that the region width of the line segment IM is W₄, the region widths of the line segment MP and line segment PO are W₂, and the region widths of the line segment MS and line segment SR are W₁.

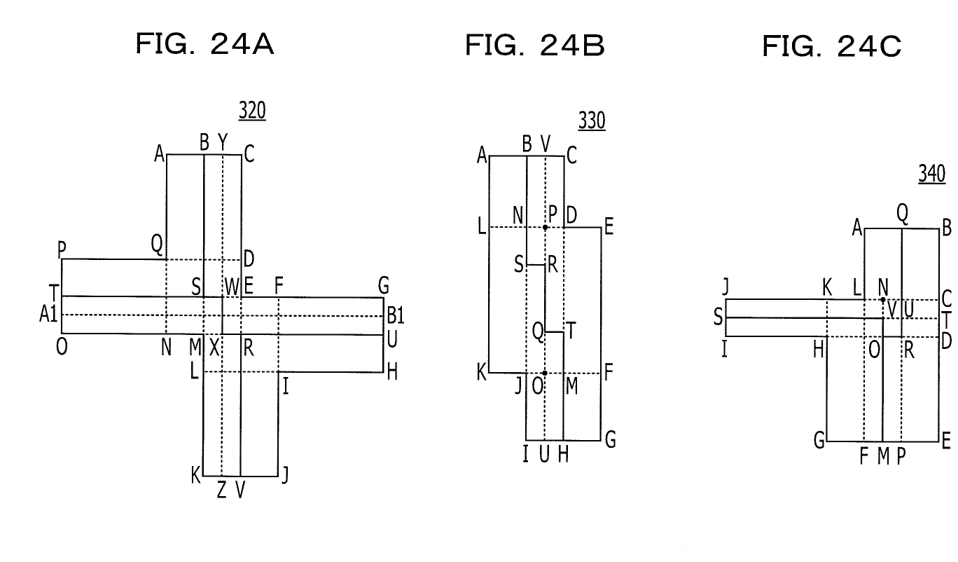

With the wiring 320 illustrated in FIG. 24A, multiple rectangular regions that are mutually not contained are a region ACRN, a region PDRO, a region SGHL, a region SFJK, a region BCVK, and a region TGUO, following rule 1.

In accordance with the rule 2, with the region ACRN, region SFJK, and region BCVK, the direction where a line segment is drawn is the Y-axis direction, and the region width is the X-axis direction. Also, with the region PDRO, region SGHL, and region TGUO, the direction where a line segment is drawn is the X-axis direction, and the region width is the Y-axis direction.

The widths of the region ACRN, region PDRO, region SGHL, and region SFJK are each W₂ (=2×W₁). Also, the widths of the region BCVK and region TGUO are W₁. Accordingly, the rank order to draw a line segment comes first regarding the region ACRN, region PDRO, region SGHL, and region SFJK, and comes later regarding the region BCVK and region TGUO in accordance with the rule 3.

First, upon attempting to draw a line segment MB, a line segment TE, a line segment MU, and a line segment VE on the symmetric axis in the longitudinal direction regarding the region ACRN, region PDRO, region SGHL, and region SFJK, which are mutually overlapped with the short side NR, short side DR, short side SL, and short side SF, respectively.

Accordingly, the line segment MB, line segment TE, line segment MU, and line segment VE have to have a drawing margin regarding the edge point M, edge point E, edge point M, and edge point E, in accordance with the rule 4, respectively.

The widths of the region ACRN, region PDRO, region SGHL, and region SFJK are all W₂, and accordingly, the lengths of the drawing margins are all a half of W₂ (W₂/2=1), and the edge point M and edge point E are both changed to a point S, and the edge point M and edge point E are both changed to a point R.

Thus, line segments to be drawn regarding the region ACRN, region PDRO, region SGHL, and region SFJK are a line segment SB, a line segment TS, a line segment RU, and a line segment VR.

Next, a line segment is drawn regarding the region BCVK. The region BCVK is overlapped with the region ACRN, region PDRO, region SGHL, and region SFJK. Also, at the time of drawing a line segment regarding the BCVK, upon attempting to draw a line segment on a line segment ZY serving as the symmetric axis in the longitudinal direction, of the line segment ZY, a line segment WY has an overlap with the line segment SB already drawn regarding the region ACRN, and accordingly, crank connection will be performed in accordance with the rule 5.

Also, of the line segment ZY, a line segment ZX has an overlap with the line segment VR already drawn regarding the region SFJK, and accordingly, crank connection will be performed in accordance with the rule 5.

Accordingly, of the line segment ZY, no line segment is drawn regarding the section ZX and section WY, and both edge points X and W of the remaining line segment XW are crank-connected to the line segment VR and line segment SB, respectively. Thus, a line segment RX and a line segment WS are generated.

Finally, a line segment is drawn regarding the region TGUO. The region TGUO is overlapped with the region ACRN, region PDRO, region SGHL, and region SFJK. Also, even when attempting to draw a line segment A1B1 on the symmetric axis in the longitudinal direction regarding the region TGUO, with the entirety of the line segment A1B1, an overlap occurs with the line segment already drawn.

Accordingly, processing for drawing a line segment regarding the region TGUO will not be performed.

Thus, with the wiring 320 illustrated in FIG. 24A, the line segment SB, line segment ST, line segment RU, line segment RV, line segment RX, line segment XW, and line segment WS are drawn. Note that the region widths of the line segment SB, line segment ST, line segment RU, and line segment RV are W₂, and the region widths of the line segment RX, line segment XW, and line segment WS are W₁.

With the wiring 330 illustrated in FIG. 24B, multiple four rectangular regions that are mutually not contained to be obtained are a region ACMK, a region NEGI, a region LEFK, and a region BCHI.

In accordance with the rule 2, with the region ACMK, region NEGI, region LEFK, and region BCHI, the direction where a line segment is drawn is the Y-axis direction, and the region width is the X-axis direction.

The width of the region LEFK is W₃ (=3×W₁), the widths of the region ACMK and region NEGI are W₂ (=2×W₁), and the width of the region BCHI is W₁.

Accordingly, in accordance with the rule 3, with regard to the rank order to draw a line segment, the region LEFK is the first, the region ACMK and region NEGI are the second, and the region BCHI is the last.

Upon attempting to draw a line segment on a line segment OP serving as the symmetric axis in the longitudinal direction of the region LEFK, other region ACMK and region NEGI are overlapped with the short side LD and short side KM of the region LEFK, and accordingly, the line segment OP has to have a drawing margin regarding the edge point O and edge point P, following rule 4. The lengths of the drawing margins are a half of the width W₂ of other region ACMK and region NEGI (W₂/2), and accordingly, the edge point O and edge point P of the line segment OP are changed to a point Q and a point R in front by W₂/2, respectively.

Thus, the line segment to be drawn regarding the region LEFK has become a line segment QR.

Next, at the time of drawing a line segment regarding each of the region ACMK and region NEGI, the region ACMK and region NEGI are overlapped with the region LEFK where the line segment RQ has been already drawn, and upon drawing a line segment JB and a line segment HD as to the region ACMK and region NEGI respectively, an overlap with the line segment QR of the region LEFK occurs.

Accordingly, in accordance with the rule 5, the line segment BS and line segment HT are crank-connected to the line segment QR. Thus, a line segment SR and a line segment QT are generated.

Thus, with the wiring 330, the line segment HT, line segment TQ, line segment QR, line segment RS, and line segment SB are drawn.

Next, upon attempting to draw a line segment on a line segment UV serving as the symmetric axis in the longitudinal direction of the region BCHI, the line segment UV is entirely overlapped with the already drawn line segment HT, line segment QR, and line segment SB from one edge U to the other edge V. Thus, no line segment occurs regarding the region BCHI.

Thus, with the wiring 330 illustrated in FIG. 24B, the line segment HT, line segment TQ, line segment QR, line segment RS, and line segment SB are drawn as resistance components. Note that the region width of the line segment QR is W₃, and the region widths of the line segment HT, line segment TQ, line segment RS, and line segment SB are W₂.

In the case of the wiring 340 illustrated in FIG. 24C, multiple rectangular regions that are mutually not contained are a region ABEF, a region KCEG, and a region JCDI in accordance with the rule 1.

In accordance with the rule 2, with the region ABEF and region KCEG, the direction where a line segment is drawn is the Y-axis direction, and the region width is the X-axis direction. Also, with the region JCDI, the direction where a line segment is drawn is the X-axis direction, and the region width is the Y-axis direction.

The width of the region ABEF is W₂ (=2×W₁), the widths of the region KCEG is W₃ (=3×W₁), and the width of the region JODI is W₁. Accordingly, in accordance with the rule 3, the rank order to draw a line segment is the order of the region KCEG, region ABEF, and region JODI.

First, upon attempting to draw a line segment MN on the symmetric axis in the longitudinal direction (Y-axis direction) regarding the region KCEG, the region ABEF is overlapped with the short side KC, and accordingly, the line segment MN has to have a drawing margin regarding the edge point N in accordance with the rule 4. The length of the drawing margin is a half of the width W₂ of another region ABEF (W₂/2=W₁), and accordingly, the edge point N of the line segment MN is changed to a point O in front by W₁.

Thus, the line segment to be drawn regarding the region KCEG has become a line segment MO.

Next, at the time of drawing a line segment regarding the region ABEF, upon attempting to draw a line segment on a line segment PQ serving as the symmetric axis in the longitudinal direction, of the line segment PQ, a line segment PR has an overlap with the line segment MO already drawn regarding the region KCEG, and accordingly, crank connection will be performed in accordance with the rule 5.

Accordingly, with regard to the region ABEF, a line segment RQ is crank-connected to the line segment MO at the point R, and accordingly, a line segment R0 is generated.

Also, at the time of drawing a line segment regarding the region JCDI, the short side CD of the region JCDI is overlapped with the region ABEF, and accordingly, a line segment ST has to have a drawing margin regarding the edge point T, following rule 4. The length of the drawing margin is a half of the width W₂ of another region ABEF (W₂/2=W₁), and accordingly, the edge point T of the line segment ST is changed to a point U in front by W₁.

Also, upon attempting to draw a line segment on a line segment SU regarding the region JCDI, of the line segment SU, a line segment VU has an overlap with a line segment OR already drawn regarding the region ABEF, and accordingly, crank connection will be performed in accordance with the rule 5.

Thus, the line segment SU is crank-connected to the line segment OR, and a line segment VO is generated.

Accordingly, with the wiring 340 illustrated in FIG. 24C, the line segment MO, line segment OR, line segment RQ, line segment OV, and line segment VS are drawn. Note that the region width of the line segment MO is W₃, the region widths of the line segment OR and line segment RQ are W₂, and the region widths of the line segment OV and line segment VS are W₁.

Thus, with regard to a wiring having various complicated patterns illustrated in FIGS. 20A to 24C, a line segment representing a resistance component may be drawn, and the region width regarding each line segment may also be obtained.

The resistance value of each line segment of the wirings illustrated in FIGS. 20A to 24C is obtained by sheet resistance×line segment length÷region width, and accordingly, the resistance value of each wiring may be calculated. With regard to the processing for obtaining a resistance value in this way, a wiring having a pattern other than the patterns illustrated in FIGS. 20A to 24C may be similarly calculated by performing the processing in accordance with the rule 1 to rule 7.

As described above, according to the resistance value calculating method according to an embodiment, even with regard to a wiring having a complicated pattern, a line segment having a resistance component may be drawn, and a resistance value may be calculated using the length and region width of each line segment.

Also, a line segment representing a resistance component is connected to a via, and accordingly, the resistance value of wiring may be calculated across multiple layers of the semiconductor circuit device, and the resistance value of the wiring and via in the entirety of the semiconductor circuit device may be obtained.

Also, data representing the resistance values of multiple line segments included in a single wiring may be obtained as table data in a determinant format as illustrated in FIGS. 19A and 19B.

Therefore, if resistance value data obtained by the resistance value calculating method according to an embodiment is employed in the resistance value database of the electromigration analyzing device as illustrated in FIG. 6, electromigration analysis regarding the entirety of the semiconductor circuit device may be performed with high precision based on the resistance value data in a determinant format, and average current data at the electromigration analyzing unit. According to an embodiment, a resistance value is calculated for different regions by applying any of the rules described herein.

Note that, with the above description, though a line segment representing a resistance component has been drawn on the center line of the region, the line segment is not necessarily drawn on the center line.

Also, in the event that the region is a regular square, an arrangement has been made wherein the longitudinal is taken as the Y-axis direction, and a line segment is drawn in the Y-axis direction, but an arrangement may be made wherein the longitudinal is taken as the X-axis direction, and a line segment is drawn in the X-axis direction.

Also, the length of a drawing margin has been set to the length of a half of the width W of another region serving as another overlapped side (W/2), but this length is not restricted to the length of a half of the width W of another region (W/2).

Description has been made so far regarding the resistance value calculating program, resistance value calculating method, and resistance value calculating device according to an instantiation embodiment of the present invention, but the present invention is not restricted to a specific described embodiment, and various modifications and changes may be performed without departing from the scope of the claims.

As described herein, embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention, the scope of which is defined in the claims and their equivalents.

What is claimed is:

1. A non-transitory, computer-readable medium storing a program causing a computer to execute an operation including calculating a resistance value of a wiring of a semiconductor circuit device, the operation comprising:
dividing the wiring into rectangular regions with each having an orthogonal coordinate system and mutually not contained;
drawing a first line segment up to a front of an edge portion of an overlapped region in which a first divided region and a second divided region overlap in a longitudinal direction of a center portion of the first divided region;
drawing a second line segment in a longitudinal direction of a center portion of the second divided region after the first line segment is drawn; and
calculating a resistance value of the first divided region and the second divided region in accordance with a length of each line segment and a width of each region.

2. The non-transitory, computer-readable medium according to claim 1, wherein a portion of the first divided region where the first line segment is drawn is a region of which a width in the longitudinal direction is wider than a width of the second divided region.

3. The non-transitory, computer-readable medium according to claim 1, wherein an event that a short side of the first line segment is overlapped with the second divided region, causes the first line segment to be drawn up to the front of the edge portion of the overlapped region.

4. The non-transitory, computer-readable medium according to claim 1, wherein the first line segment is drawn from an edge portion of the overlapped region to a position equivalent to a half length of a width as to the longitudinal direction of the second divided region.

5. The non-transitory, computer-readable medium according to claim 1, wherein an edge point of the second line segment is drawn so as to be connected to the first line segment.

6. The non-transitory, computer-readable medium according to claim 1, wherein in an event that the second line segment has a section overlapped with the first line segment in a direction where the second line segment is drawn, the second line segment is not drawn in the overlapped section, and a portion of the second line segment other than the overlapped section is connected to the first line segment in a crank shape.

7. The non-transitory, computer-readable medium according to claim 1, wherein a line segment included in the wiring is scanned in a first axis direction and a second axis direction in the orthogonal coordinates, and is divided into a plurality of rectangular regions that mutually do not contain the wiring.

8. The non-transitory, computer-readable medium according to claim 1, causing the computer to execute via position adjustment for shifting, in an event that the center position of a via included in the semiconductor circuit device is not positioned on the first line segment or the second line segment, the center position of the via onto the first line segment or onto the second line segment.

9. A method of a computer calculating a resistance value of a wiring of a semiconductor circuit device, the method comprising:
dividing the wiring into rectangular regions with each having an orthogonal coordinate system and mutually not contained;
drawing a first line segment up to a front of an edge portion of the overlapped region in which a first divided region and a second divided region overlap in a longitudinal direction of a center portion of the first divided region;
drawing a second line segment in a longitudinal direction of a center portion of the second divided region after the first line segment is drawn; and
calculating a resistance value of the first divided region and the second divided region in accordance with a length of each line segment and a width of each region.

10. A resistance value calculating device comprising:
a dividing unit configured to divide a wiring of a semiconductor circuit device into a plurality of rectangular regions that are mutually not contained in an orthogonal coordinate system;
a first line segment generating unit configured to draw, regarding a first region and a second region that have an overlapped region of the plurality of regions obtained by the dividing unit, a first line segment up to a front of a predetermined length of an edge portion of the overlapped region in a longitudinal direction of a center portion of the first region;
a second line segment generating unit configured to draw a second line segment in a longitudinal direction of a center portion of the second region after the first line segment generating unit draws the first line segment; and
a resistance value calculating unit configured to calculate a resistance value according to a line segment length and a region width regarding each of the first line segment and the second line segment.

11. A resistance value calculating device, comprising:
a processor to execute a procedure, the procedure including:
dividing a wiring of a semiconductor circuit device into a plurality of rectangular regions that are mutually not contained in an orthogonal coordinate system;
drawing, regarding a first region and a second region that have an overlapped region of the plurality of regions obtained by the dividing, a first line segment up to a front of a predetermined length of an edge portion of the overlapped region in a longitudinal direction of a center portion of the first region;
drawing a second line segment in a longitudinal direction of a center portion of the second region after the first line segment is drawn; and
calculating a resistance value according to a line segment length and a region width regarding each of the first line segment and the second line segment.
